(19) United States
(12) Patent Application Publication
(10) Pub. No.: US 2020/0139655 A1
(43) Pub. Date: May 7, 2020

(54) Portable Compaction Apparatus for Compacting Trash and Other Materials

(71) Applicant: Fred Roberts, Clarksville, TN (US)

(72) Inventor: Fred Roberts, Clarksville, TN (US)

(21) Appl. No.: 16/564,119

(22) Filed: Sep. 9, 2019

Related U.S. Application Data
(60) Provisional application No. 62/728,722, filed on Sep. 7, 2018.

(51) Int. Cl. B30B 1/20; B30B 15/06

(52) U.S. Cl. CPC B30B 1/20; B30B 15/062

(57) ABSTRACT

Embodiments of the apparatus of this disclosure can comprise a portable compactor apparatus for compacting material in a container, wherein the portable compactor apparatus comprises
a. At least one base support,
b. A linear actuator attached to the at least one base support, the linear actuator having an extendable and retractable shaft, the shaft having a proximal end within the actuator and a distal end,
c. A compression head connected to the distal end of the shaft, and
d. Control means for controlling extension and retraction of the shaft,

The container having a top lip portion, the base support positioned on the top lip portion, the linear activator having a first position and a second position, in the first position the shaft is fully retracted into the linear actuator, in the second position the shaft is extended further below the top lip portion of the container.

### CROSS-REFERENCES TO RELATED APPLICATIONS

This application claims the benefit of provisional application 62/728,722 “Portable Compaction Apparatus for Compacting Trash and Other Materials,” filed Sep. 7, 2018, the contents of which are incorporated by reference in their entirety.

### STATEMENT REGARDING FEDERALLY SPONSORED RESEARCH OR DEVELOPMENT

Not Applicable.

### PARTIES TO A JOINT RESEARCH AGREEMENT

Not Applicable

### FIELD OF THE INVENTION

This disclosure is directed towards portable units for compacting trash or other material inside a container and their control systems and components.

### BACKGROUND OF THE INVENTION

Improvements are needed for methods and devices for compacting trash and other materials in containers stored on-site at business and residential locations.

### SUMMARY OF THE INVENTION

In an embodiment, the apparatus of the disclosure comprises a portable compactor apparatus for compacting material in a container, wherein the portable compactor apparatus comprises at least one base support, a linear actuator attached to the at least one base support, the linear actuator having an extendable and retractable shaft, the shaft having a proximal end within the actuator and a distal end, a compression head connected to the distal end of the shaft, and control means for controlling extension and retraction of the shaft within the container. The container has a top lip portion, the base support positioned on the top lip portion, the linear activator having a first position and a second position, in the first position the shaft is fully retracted into the linear actuator, in the second position the shaft is extended further below the top lip portion of the container.

In an embodiment, the apparatus of the disclosure comprises a portable compactor apparatus for compacting material in a container, wherein the portable compactor apparatus comprises a stationary base post connected to one or more base supports, a movable top post wherein the top post is movable relative to the base post and the inner diameter of the top post is greater than the outer diameter of the base post, a compression head connected to the top post and the base post by connectors wherein the compression head and connectors are configured to enable the compression head to extend in a direction perpendicular to the top post and base post during compacting operation and to allow the compression head to be folded in a direction parallel to the top post and base post when the apparatus is not in use, a compacting platform attached to the compression head and configured below the compression head wherein the compacting platform comprises a plurality of spikes extending below the bottom of the compacting platform, and control means for controlling the vertical movement of the top post and compression head.

### BRIEF DESCRIPTION OF THE DRAWINGS

FIG. 1 is a photograph showing an embodiment of the apparatus wherein the base of the apparatus is outside the container.

FIG. 2 is a drawing showing a perspective of an embodiment of the apparatus.

FIG. 3 is a drawing showing an embodiment of the apparatus with the ram arm folded down, for storage of the apparatus when not in use.

FIG. 4 is a side view and end view perspective of an embodiment of the compression arm.

FIG. 5 is a detail of an embodiment of the post assembly with a hand crank used to provide power for moving the top post.

FIG. 6 is a drawing showing additional detail of an embodiment of the apparatus using a hand crank.

FIG. 7 is a drawing showing details of an embodiment of the connections used to attach the compression arm to the top post and base post.

FIG. 8 is a drawing showing details of an embodiment of the compression arm.

FIG. 9 is a drawing showing details for an embodiment of the drive rod used in the apparatus.

FIG. 10 is a drawing showing a top view of an embodiment of the compression head.

FIG. 11 is a drawing showing an embodiment of a formed housing channel.

FIG. 12 is a drawing showing details for an embodiment of components used in the compression arm.

FIG. 13 is a drawing showing an embodiment of the endplate.

FIG. 14 is a drawing showing details for an embodiment of the compression plate.

FIG. 15 is a drawing showing an embodiment of the components of the compression plate.

FIG. 16 is a drawing showing additional detail for an embodiment of the foot-shield attachment.

FIG. 17 is a drawing showing an embodiment of the assembly detail for the compression foot and compression plate.

FIG. 18 is a drawing showing details for an embodiment of the compression foot with spikes.

FIG. 19 is a drawing showing an embodiment of the apparatus.

FIG. 20 is a drawing showing an embodiment of the apparatus using a linear actuator.

FIG. 21 shows an embodiment of the portable apparatus with a linear actuator using a photovoltaic cell as a power source.

FIG. 22 shows an embodiment of the portable apparatus being connected to a photovoltaic cell as a power source.

FIG. 23 shows an embodiment of the portable apparatus being connected to a photovoltaic cell as a power source.

FIG. 24 shows an embodiment of the portable apparatus disconnected from the photovoltaic cell.

FIG. 25 shows an embodiment of the photovoltaic cell with stand for the portable apparatus.

FIG. 26 shows an embodiment of the portable apparatus being placed into position on the container.

FIG. 27 shows an embodiment of the portable apparatus in position on the container.

FIG. 28 shows an embodiment of the portable apparatus in position on the container.

FIG. 29 shows an embodiment of the portable apparatus in position on the container prepared for operation.

FIG. 30 shows an embodiment of the portable apparatus in position on the container with the compression arm beginning to extend downward into the container.

FIG. 31 shows an embodiment of the portable apparatus in position on the container with the compression arm beginning to extend downward into the container.

FIG. 32 shows an embodiment of the portable apparatus in position on the container with the compression arm to extending further downward into the container.

FIG. 33 shows an embodiment of the portable apparatus in position on the container with the compression arm to extending further downward into the container.

FIG. 34 shows an embodiment of the portable apparatus in position on the container with the compression arm to extending further downward into the container.

FIG. 35 shows an embodiment of the portable apparatus in position on the container with the compression arm fully extended and resting on a protrusion inside the container.

FIG. 36 shows an embodiment of the compactor using a solar module to provide power to the compactor and where the base post of the compactor is secured to the ground.

FIG. 37 shows an embodiment of the portable compactor using two additional support rods provide extra support for the crush foot.

FIG. 38 shows an embodiment of the portable compactor using two additional support rods provide extra support for the crush foot with the crush foot extended below the base supports.

FIG. 39 shows an embodiment of the portable trash compactor where additional handles attached to the extension arms can be used to aid in moving and positioning the compactor

FIG. 40 shows an embodiment of the portable trash compactor of FIG. 39 where the crush foot is extended below the supports.

FIG. 41 shows an embodiment of the compactor using a stand comprising wheels and a platform for supporting the trash container and a scissor jack to move the crush foot.

FIG. 42 shows an embodiment of the compactor using a stand comprising wheels and a platform for supporting the trash container and a linear actuator to move the crush foot.

### DETAILED DESCRIPTION OF THE INVENTION

Improvements are needed for methods and devices for compacting trash and other materials in containers stored on-site at business and residential locations.

The apparatus of this disclosure can provide several advantages over current waste management practices. By compacting the trash inside the pick-up container at the residential or business location, the apparatus eliminates the need (and cost) for a separate trash compaction cabinet. No additional disposal bags are required for holding the compacted trash. The apparatus can use the street container itself as a retainer for the garbage, eliminating the need to empty the heavy bag of previously compacted garbage. The apparatus enables current waste collection trucks to pick up the compacted trash in regular street pick-up containers rather than requiring trucks capable of lifting larger, heavier containers. Regular compaction in the pick-up container can also reduce the number of weekly compacting cycles needed or reduce the required frequency of collections. The apparatus comprises a small number of moving parts and the parts can be inspected without disassembling the apparatus.

Additional benefits provided by the compactor include the reduction of both insects and pests that are attracted to the smell, and the elimination of the need to stack waste on top of or beside the waste container. This practice often results in garbage being scattered by both pests and wind. This machine may eliminate the need for an in-house compactor and can be used when the container will not close due to over filling. The compactor can generate a force of 225-1320 lbs and efficiently compacts enough to eliminate the need for extra containers. The compactor ram foot can be equipped with protected spikes that puncture containers with lids that produce resistance to compaction. These spikes are shielded by a spring-loaded pressure plate that prevents accidental puncture of the hands when handling and serves to remove punctured containers from the spikes when the ram is retracted. When not in use, the compactor can be placed on a small pedestal behind the can for storage.

In embodiments, the apparatus can comprise a docking station that the container can rest on. The apparatus can comprise a movable top post and a stationary base post that are located outside the container when the apparatus is in use. In embodiments, the apparatus can comprise one or more wheels for easier transport of the apparatus or container (such as to a power source). In an embodiment, the compression arm can extend from the top post and stationary post in a radial direction.

In embodiments, the apparatus can comprise a drive shaft used for controlling the movement of the top post. In other embodiments, the apparatus can comprise a drive shaft for controlling movement of the compression arm. In other embodiments, the drive shaft is connected to a motor or handcrank that provides power to turn the shaft.

In embodiments, the compactor can generate a force of 225-1320 lbs and can efficiently compact enough material to reduce or even eliminate the need for extra containers. The compactor ram foot can be equipped with protected spikes that puncture containers with lids that produce resistance to compaction. In embodiments, the spikes are shielded by a spring-loaded pressure plate that prevents accidental puncture of the hands when handling and serves to remove punctured containers from the spikes when the ram is retracted. When not in use, the compactor is can be placed on a small pedestal behind the can for storage.

In embodiments, the compactor can be powered by a 1 amp-hr lead acid battery (12 V) rechargeable by both solar panel or conventional charger without removing it from the compactor. In other embodiments, the compactor can be hand-powered by a handcrank.

In embodiments, the apparatus can provide for two-stage compacting by pre-compressing loads that are piled on top of the container to the top of the container for the first stage compaction and then using the ram foot to performs the second stage of compacting by compressing the trash below the top. In embodiments, the ram foot can comprise spikes that can puncture containers in the trash to reduce air pressure resistance. In embodiments, the spikes are protected by a safety pressure plate which also protects hands and other body parts or other items from being accidentally damaged by the spikes when the apparatus is not performing compaction operations. In embodiments, the compression foot is adjustable and can be rotated to cover areas where compaction has hard spots such as jugs or drink containers with caps. In embodiments, components of the apparatus such as the compression arm, ram feet, or other parts can be folded away into a more compact shape for storage and easier transport when not in use.

In some embodiments, the shaft extends deep into the container such that the foot and/or compression head reaches the bottom of the container. In some embodiments the shaft extends such that the foot and/or compression head reaches a point short of the bottom of the container but into the deepest quarter of the container. In some embodiments the shaft extends such that the foot and/or compression head reaches a point short of the deepest quarter of the container but into the deeper half of the container. In some embodiments the shaft extends such that the foot and/or compression head reaches a point short of the deeper half of the container but into the deeper ¾ of the container. In some embodiments the shaft extends such that the foot and/or compression head reaches a point short of the deeper ¾ of the container but into the shallowest quarter of the container.

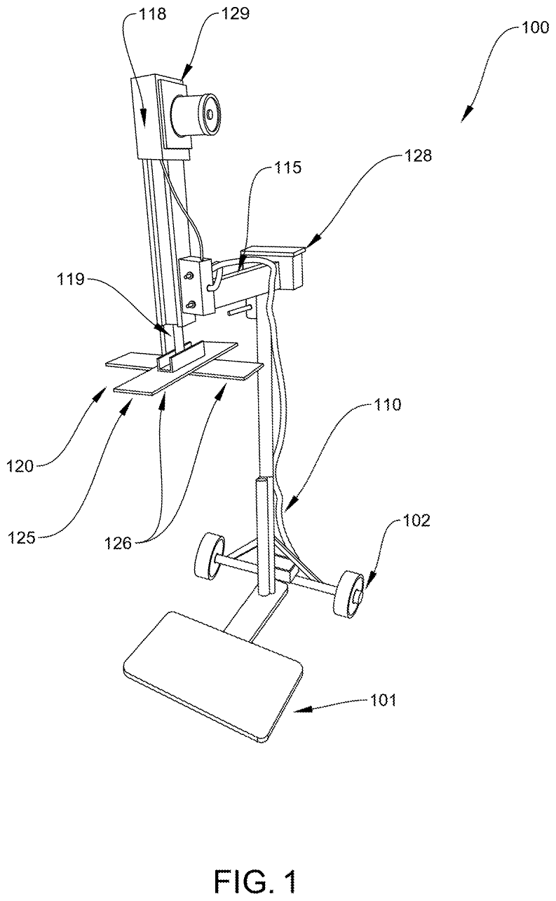

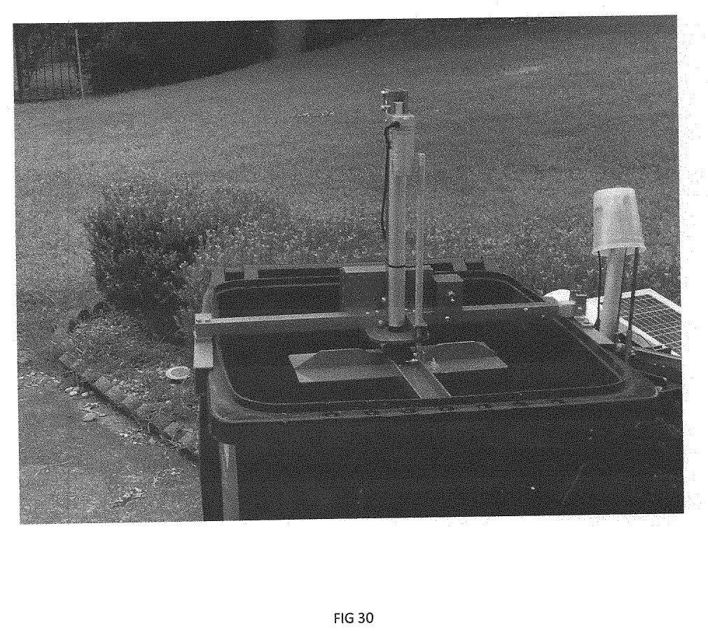

Further details on embodiments of the apparatus are shown in FIGS. 1-42.

In an embodiment shown in FIG. 1, a movable compactor 100 comprises a base 101 that a trash container can sit on and wheels 102. Base post 110 extends upward from the base. Connection arm 115 is connected to the post and extends in a perpendicular direction. A linear actuator 118 attached the connection arm includes an extendable and retractable shaft 119. The shaft has a proximal end within the linear actuator and a distal end that is connected to the compression head 120. The compressor head can comprise additional plates 125 and 126 that are arranged in a cross direction relative to each other. Motor 128 can be used to move the connection arm 115 up and down on the base post. The connection arm can be lowered or extended into a trash container to provide an initial level of compaction to the contents of the container. In some embodiments, the connection arm can be extended up to 6 inches, up to 8 inches, or up to 10 inches into the container. Motor 129 powers the linear actuator which can raise or lower the compression head 125 which can include plates 126 that extend in a transverse direction from the shaft 119. Lowering the compression head provides further compaction of the contents of the container. In embodiments, the compression head can be extended up to 10 inches, up to 12 inches, up to 16 inches, or up to 24 further into the container.

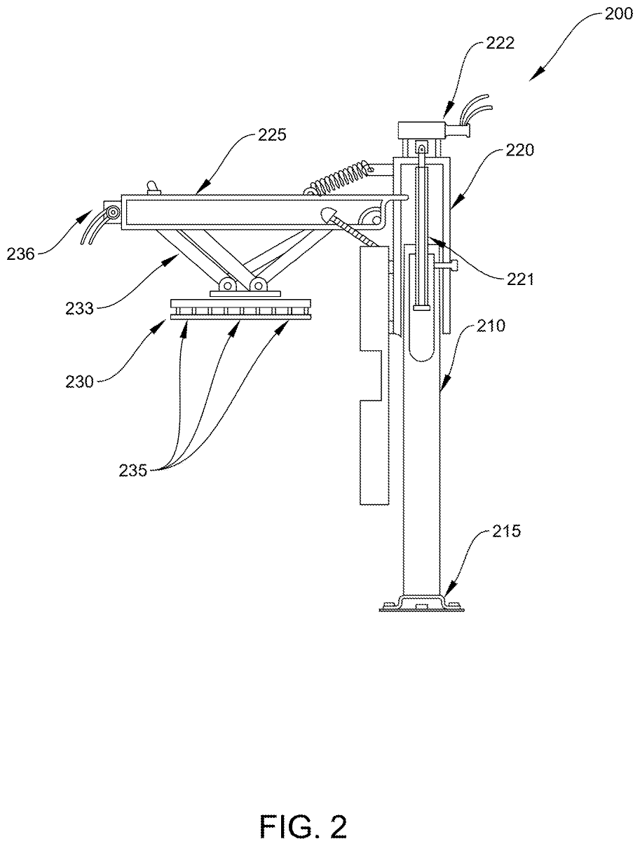

In an embodiment shown in FIG. 2, the compactor 200 comprises a base post 210 having an outer diameter. The bottom of the base post fits into to a pipe flange 215. A top post 220 with an inner diameter greater than the outer diameter of the base post extends above the top of the base post; the top end of the base post extends into the inner diameter of the top post. A threaded rod 221 extends through at least a portion of the inner diameter of the top post and the inner diameter of the base post. A motor 222 controls movement of the threaded rod which allows the top post to move up or down the threaded rod. A compression arm 225 connects to the top post and extends in a transverse direction from the top post. The compression head 230 is located below the compression arm and is connected to the compression arm by scissor jacks 233. The compression head can also include spikes 235 to aid in compaction of the trash in the container. A motor 236 is used to control the movement of the scissor jacks to raise and lower the compressor head.

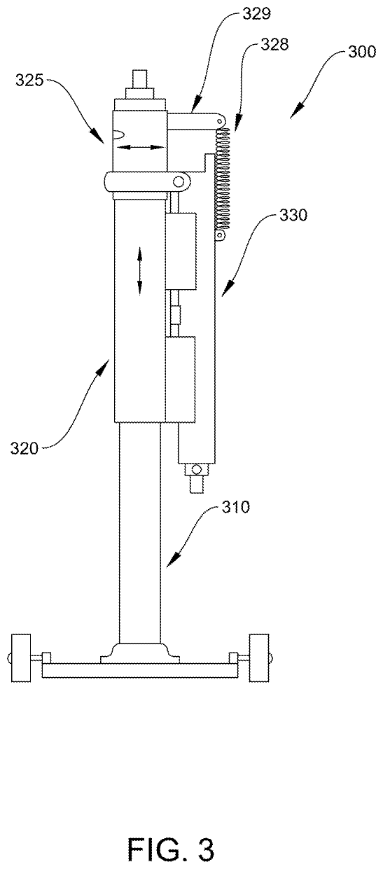

The compactor can be folded away to take up less storage space when not in use. In an embodiment shown in FIG. 3, the positions of the components in compactor 300 are shown when the compactor is not in use. The compressor arm 330 is folded down in a direction parallel to the top post 320 and base post 310. Spring 328 connecting the compressor arm to the connector 329 is extended. Sleeve 325 fits over the top post and is connected to compression arm using spring 328 and connector 329. The sleeve allows the compressor arm to pivot with respect to the top post and also can allow the compressor arm to rotate around the top post. In embodiments, the compression arm can rotate up to 90 degrees on the top post. In other embodiments, the compression arm can rotate up to 180 degrees on the top post.

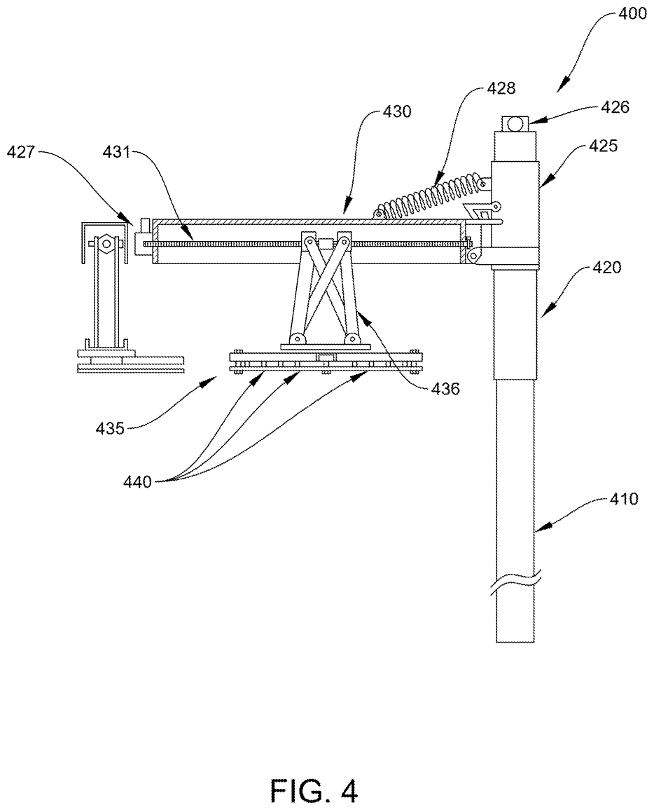

In an embodiment shown in FIG. 4, a side view perspective of a compactor 400 is shown. In this figure, the compression arm 430 is extended in a transverse direction from the top post 420. The compression arm is attached to sleeve 425 which fits over the top post, allowing the compression arm to rotate around the top post. Movement of the compression arm can be controlled by a motor 426 located at the top of the top post. The motor can be a 12-V motor with power supplied by a battery, an outlet, or a solar energy module. In the configuration shown in FIG. 4, the spring 428 which is part of the connection that connects the compression arm to the sleeve, is in a compressed state. In this configuration, the compression head 435 is located below the compression arm and is connected to the connection arm by scissor jacks 436. A motor 427 located on the compression arm controls the scissor jack movement by rotating the threaded rod 431 which is connected to the scissor jacks, allowing the compression head to be raised and lowered to provide compaction. Optional spikes 440 at the bottom of the compression head can be used to puncture bottles, cans, and other items in the trash to improve the compaction of the trash.

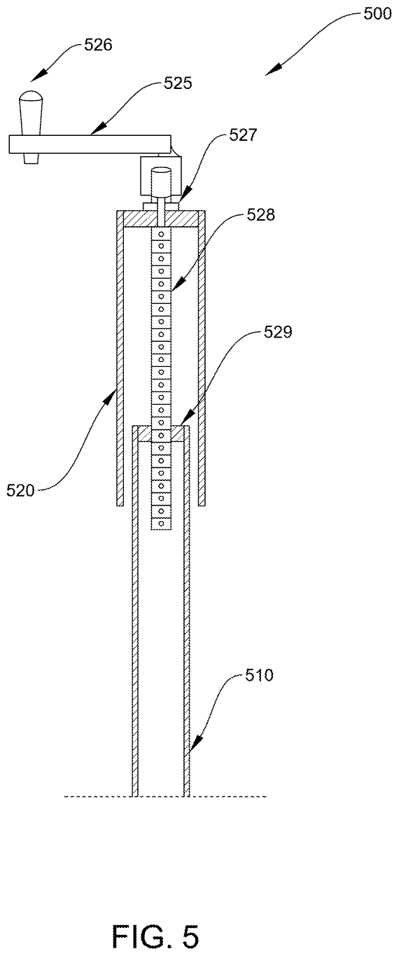

Alternate power means can be used to provide power to the compactor. FIG. 5 shows an embodiment of the compactor where a hand crank can be used to control the vertical movement of the compression arm relative to the base post. A side view 500 shows components of this embodiment. In this embodiment, the base post 510 can be a pipe with an inner and outer diameter. In embodiments, the base post can comprise 3-½″ STL pipe. The top post 520 has an inner diameter larger than the outer diameter of the base post. In embodiments where the base post comprises 3-½″ STL pipe, the top post can comprise 3-¾″ STL pipe with a ⅛″ wall thickness. A threaded rod 528 extends through a portion of the inner diameter of both the top post and the base post. The threaded rod extends through a threaded collar 529 connected to the inner wall of the base post. The threaded rod can fit through a slip-fit fitting 527 located near the top of the top post. The threaded rod is connected at one end to a hand crank 525 with handle 526. The user can turn the handle of the crank to turn the threaded rod and control movement of the compression arm (not shown) up and down the length of the top post and base post. In embodiments, the threaded rod can comprise ⅞″-9 UNC thread material and can have a length of between 10 and 20 inches. The threaded collar can have a length of 0.5″-1″ and can comprise ⅞″-9 UNC thread material. A second threaded collar can be located in the inner diameter of the top post below the slip-fit fitting.

Compactors can be vertical models that utilize a base post and a compression arm that swings and positions the crush foot into the opening of the trash container without resting on the trash container do not damage the container/cart and therefore are able to exert up to 4000 lbs. of pressure. An electrically operated scissor jack can provide this force for compaction. A linear actuator can also be used on these compactor designs to raise and lower the compression arm so that the garbage cart can be loaded to the top or higher than the top of the trash container. The linear actuator can then be used to lower the compression arm to compress the garbage to the set height of the trash container, and then the scissor jack can be used to lower the crush foot to compress the garbage further. The linear actuator then reverses and raises the swing arm until the crush plate clears the top of the container so that the lid can close. Linear actuators can also be used on the vertical models where total height is not a factor. They can apply up to 2000 lbs. of force.

The vertical modes can be stationery versions that are placed in the ground or attached to a wall or other structure that is mounted in the ground where the garbage container is normally placed. The swing arm can be moved to the side and lowered so that it presents a less noticeable profile. The benefit is the trouble-free and convenient operation of the unit when needed.

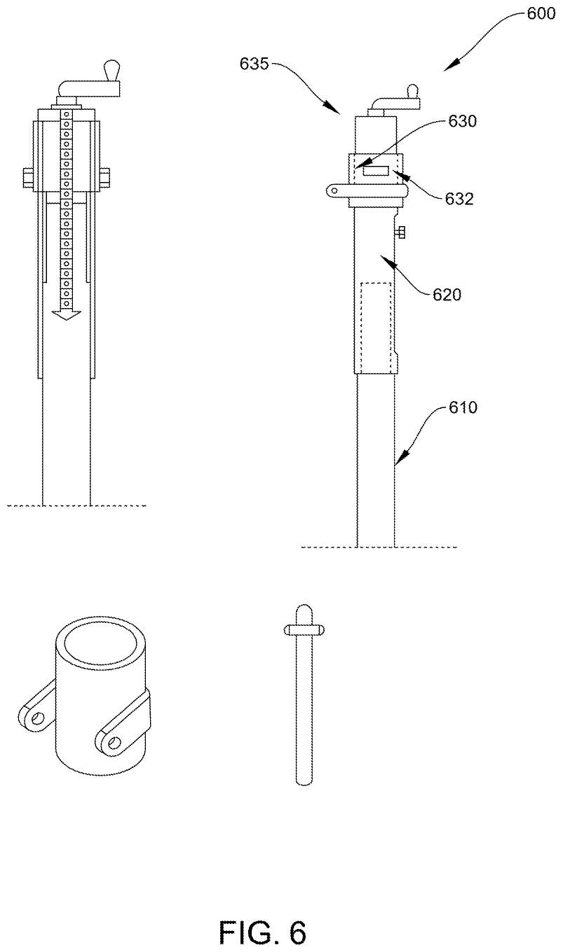

FIG. 6 shows additional features that can be used with embodiments of the compactor. The embodiment shown in FIG. 6 comprises a hand crank though other sources of power could be used. Portions of the compactor 600 shown include the base post 610 and top post 620. A sleeve assembly 630 comprising a slot 632 is located on the upper portion of the top post, below the hand crank 635. The sleeve assembly with the slot can be used to prevent the top post from turning when the handle of the hand crank is turned. The slot of the sleeve assembly can be used in conjunction with a shoulder bolt in the inner diameter of the top post. The slot can be cut 90 degrees along the circumference of the sleeve to allow the sleeve to swing around in use while a portion of the shoulder bolt is engaged with the slot.

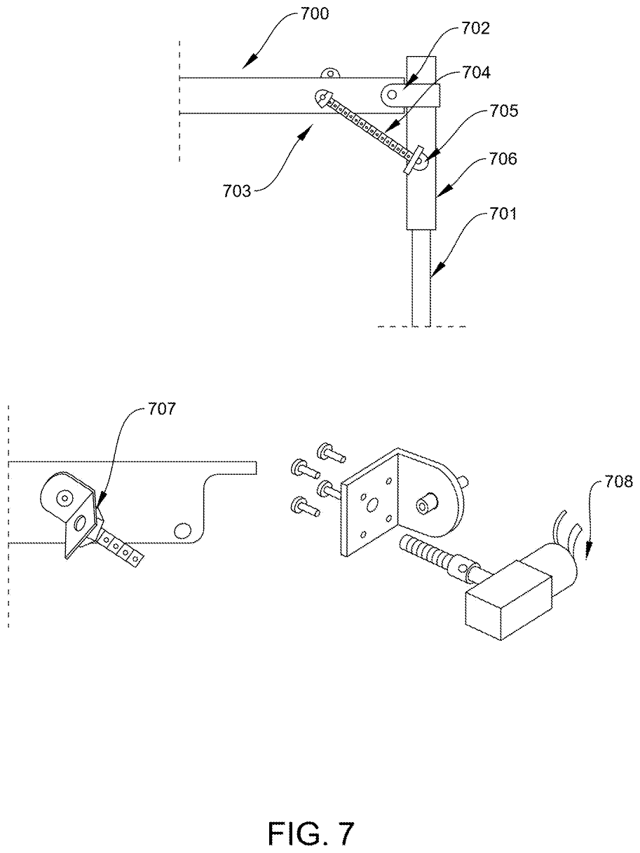

FIG. 7 shows features of an embodiment of the compactor wherein the compression arm 700 can be moved to a position next to and parallel to the base post 701 for easier storage when the compactor is not in use. In this embodiment, the compression arm pivots around pivot point 702. A pivot bracket 703 located near the pivot point on the compression arm is connected by a threaded rod 704 to a mounting bracket 705 located on the top post 706. The threaded rod can be screwed into a nut 707 welded to the pivot bracket. As a motor 708 turns the threaded rod, it can rotate the compression arm downward from a position approximately perpendicular to the top post and base post to a vertical position parallel and next to the top and base post. The pivot bracket and mounting bracket can both rotate as the compression arm moves. In an embodiment, a 12-volt motor can be used to turn the threaded rod.

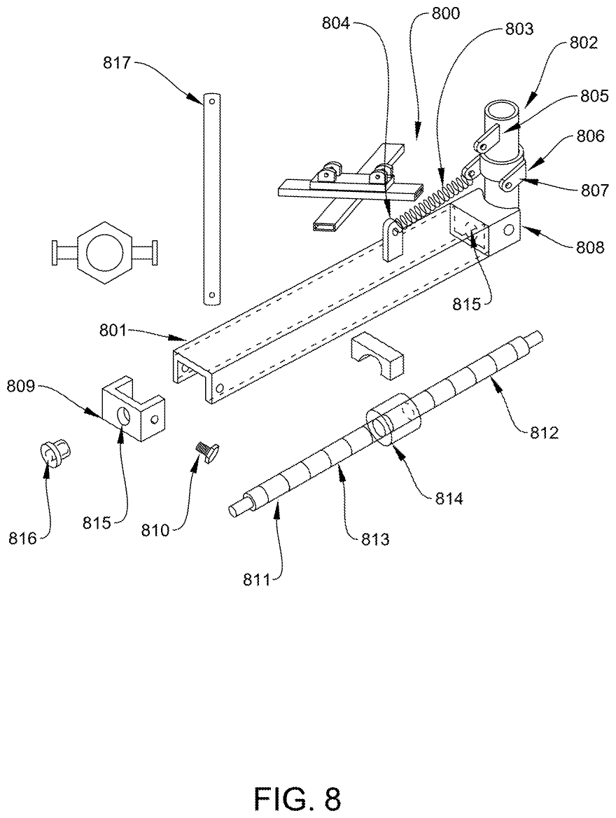

The compression arm can utilize a scissor jack to control the movement of the compression foot. In the embodiment shown in FIG. 8, the compressor arm 800 comprises a formed housing channel with a C-shaped cross-section 801 and is connected to the top post 802 using a spring 803 connected to a bracket 804 on the top of the compression arm and a bracket 805 on the outer radius of the top post. In addition, a steel collar with welded tabs 806 is also positioned around the top post below the bracket on the top post. The welded tabs have openings 807 sized to fit a bolt that fits through the tab openings, the openings in a first endcap 808, and the openings in the compression arm to connect the compression arm to the steel collar and provide support for the compression arm. In an embodiment, the bolt can be a 2-inch long hexagonal bolt with a 1/14-20×⅝ thread. A second endcap 809 can be secured to the compression arm at the other end of the compression arm using a similar bolt 810. Both endcaps can have an opening on the side of the endcap perpendicular to the compression arm that is sized to fit a threaded rod 811 positioned within the C-shaped cross section of the compression arm. The threaded rod comprises two sections, one section 812 with a right-handed thread and the other section 813 with a left-handed thread. One end of each section is threaded into a sleeve 814. The threaded rod can be ⅞ inch diameter and the sleeve can be steel. The other end of each rod can then be threaded into openings 815 on the two opposite endplates; one end of the right-handed thread section can be inserted into the opening on the endplate nearest the top post while one end of left-handed thread section can be inserted into the opening on endplate furthest from the top post. The end of sections can comprise an extension that is of smaller diameter than the threaded rod portions. In some embodiments, the extensions at the end portions of the rod sections can be 0.5 inches in diameter. A Teflon bearing 816 can be used between the sleeve and the compression arm to provide additional fit and control with lower friction loss. Teflon bearings and/or bushings can also be used with the endplate openings. A rod attached to the compression arm can provide additional support and prevent unwanted rotation of the compression arm when it is used to compact trash. The rods can be 1-in diameter with a 3/16-in wall thickness.

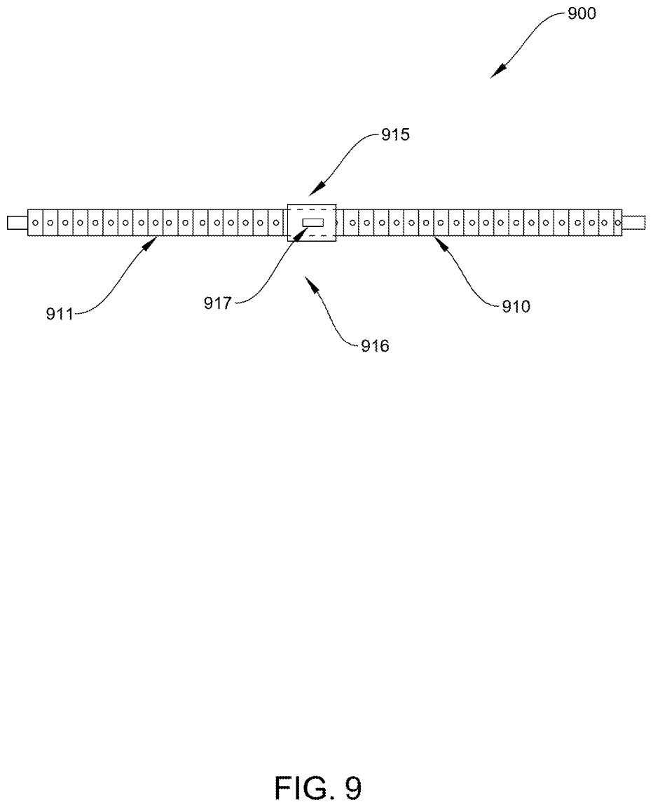

Additional details of an embodiment of the threaded rod assembly 900 are shown in FIG. 9. The assembly comprises two threaded rod sections 910 and 911 whose ends are connected together inside a sleeve 915 comprising a dowel 916 and an opening 917. Retainer washers 920 can be used at the other ends of the threaded rod section to secure them in place to the compactor assembly. In this embodiment, threaded rod section 911 comprises a left-hand threaded rod and threaded rod section 910 comprises a right-hand threaded rod. Each threaded rod section has one end that is threaded into the sleeve. The sleeve further comprises an opening and a dowel that can be inserted into the opening to limit the movement of the sleeve. In embodiments, rod section 910 can comprise RH ⅞″-9 Thread material and rod section 911 can comprise LH ⅞″-9 Thread material. The sleeve can comprise steel or other metal and can have a diameter of 1-¼″ and a length of 2 inches. The combined length of the two rod sections 910 and 911 can be between 20 and 36 inches, preferably between 24 and 30 inches. In an embodiment, the combined length of the threaded rod sections can be 27 inches. The dowel used with the sleeve can be ¼″ in diameter with a 1-½″ length with the opening sized to fit the dowel.

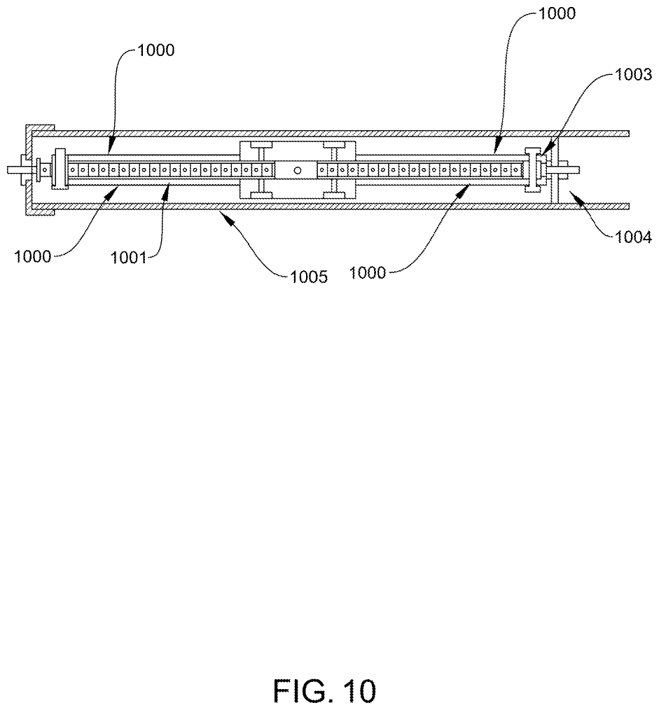

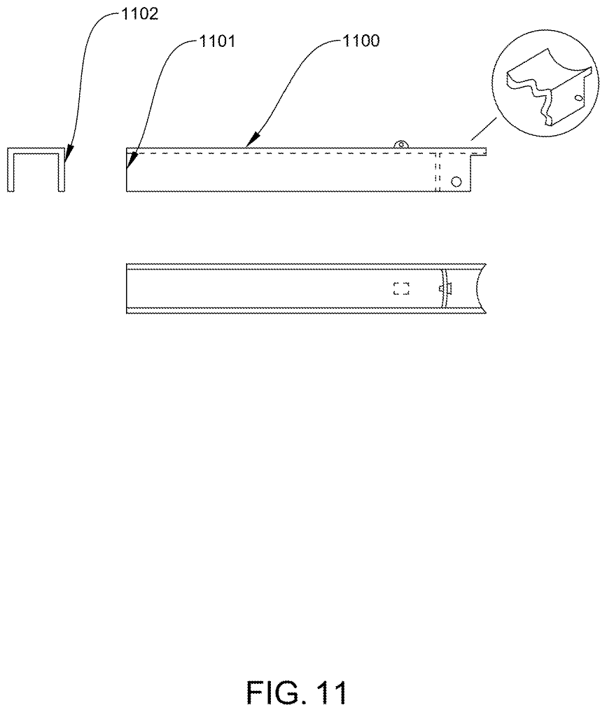

FIG. 10 shows additional features of an embodiment of the compactor. In this embodiment, four rods 1000 are positioned parallel to the threaded rod/drive screw 10001. The rods can be attached to the end caps on the compression arm or to the compression arm body 1005. In an embodiment, a ⅞-9 UNC nut can be welded to the compression arm and shoulder bolts 1003 can be used to help secure the rod into the nut. Optional ribs 1004 can be placed along the length of the compression arm to provide additional strength and stiffness. The compression arm can comprise a formed housing channel as shown in FIG. 11. The outside width 1101 of the housing can be 4 inches and the height 1102 of the housing can be 2 inches. The housing channel can have an overall length of 31.5 inches. The wall thickness of the material used to make the formed housing channel can be 0.25 inches.

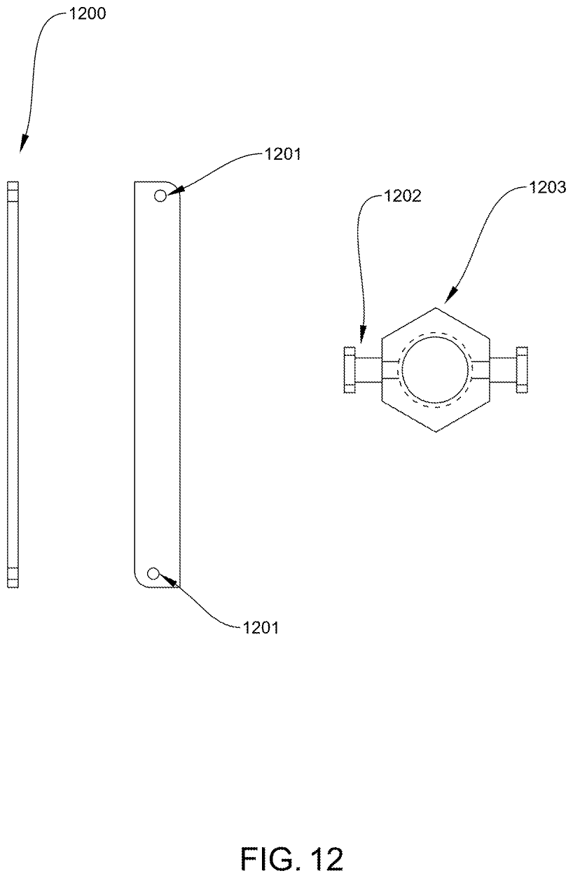

The compression rods can comprise openings 1201 at both ends that are sized to fit a shoulder bolt 1202 as shown in FIG. 12. In an embodiment, the openings are sized to fit a ¼-in diameter shoulder bolt. In an embodiment, the compression rods have an overall length of 14.5 inches. A drive nut 1203 can be used to secure the compression rods in place. In an embodiment, the drive nut can be a ⅞-9 hexagonal nut with an outer width of 1.4375 inches. The nut can comprise openings for shoulder bolts. In an embodiment, the shoulder bolts are ¼-20 thread× 13/32-in diameter.

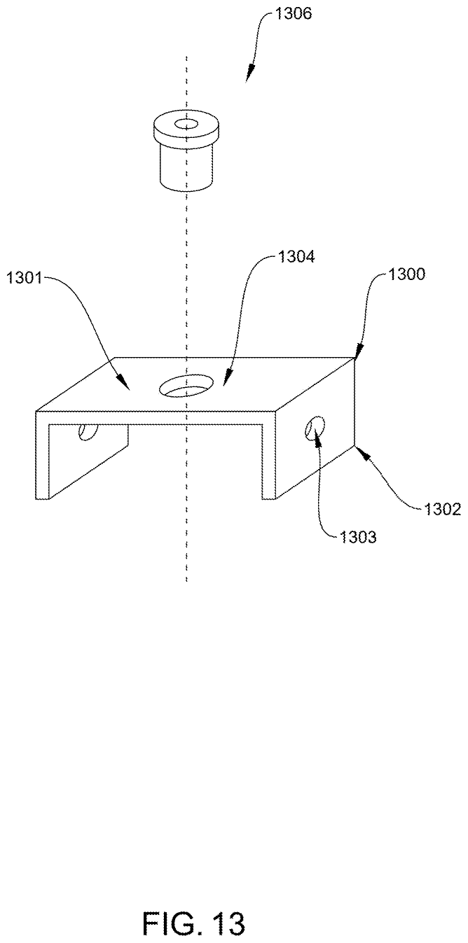

FIG. 13 shows features of an end plate 1300 used in an embodiment of the compactor. The end plate comprises a formed bracket with a C-shaped cross-section with a first face 1301 and two faces 1302 extending downward from this face parallel to each other. The two parallel faces have openings 1303 sized to receive a bolt for attaching the end plate to the compression arm. The first face has an opening 1304 sized to receive a portion of the threaded rod section. In an embodiment, the end plate can comprise 3/16-in thick steel. The first face can have a width of 3.5 inches to 4.5 inches and a length of 3.5 inches to 4.5 inches. The parallel faces can have a length of 3.5 to 4.6 inches and a width of 1.5 to 2.5 inches. In an embodiment, a bushing 1306 can be used as part of the connection to the threaded rod section. In embodiments, the bushing can be made of bronze. In embodiments, the bushing can have a ½-in inner diameter.

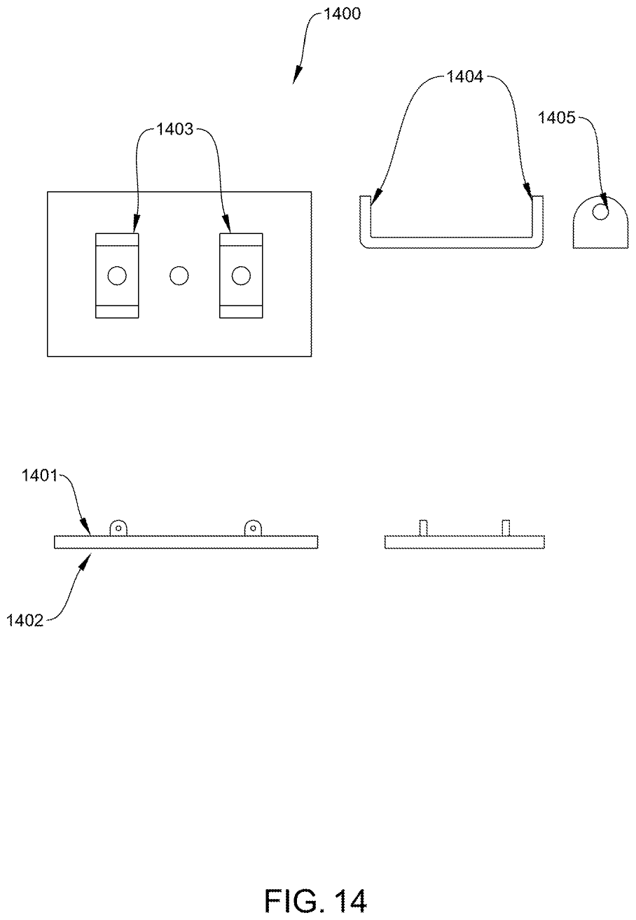

The compression plate can comprise a rectangular sheet having a top face 1401 and a bottom face 1402 and a thickness as shown in FIG. 14. The compression plate can further comprise two or more brackets 1403 on the top face that can be used in securing the compression plate. In embodiments, the compression plate can have a length of 5 to 7 inches, preferably 6 inches, and a width of 3 to 5 inches, preferably 3.875 inches. In an embodiment the brackets can comprise steel with a 3/16-in thickness. The brackets can comprise tabs 1404 that extend upward from the compression plate with tab openings 1405. In an embodiment, the tab openings can be tapped openings for receiving a threaded insert. In embodiments the threaded insert can be a ¼-20 bolt. In an embodiment, the brackets are welded to the top surface of the rectangular plate. In an embodiment, the brackets are connected to the compressor plate using a separate nut and bolt for each bracket.

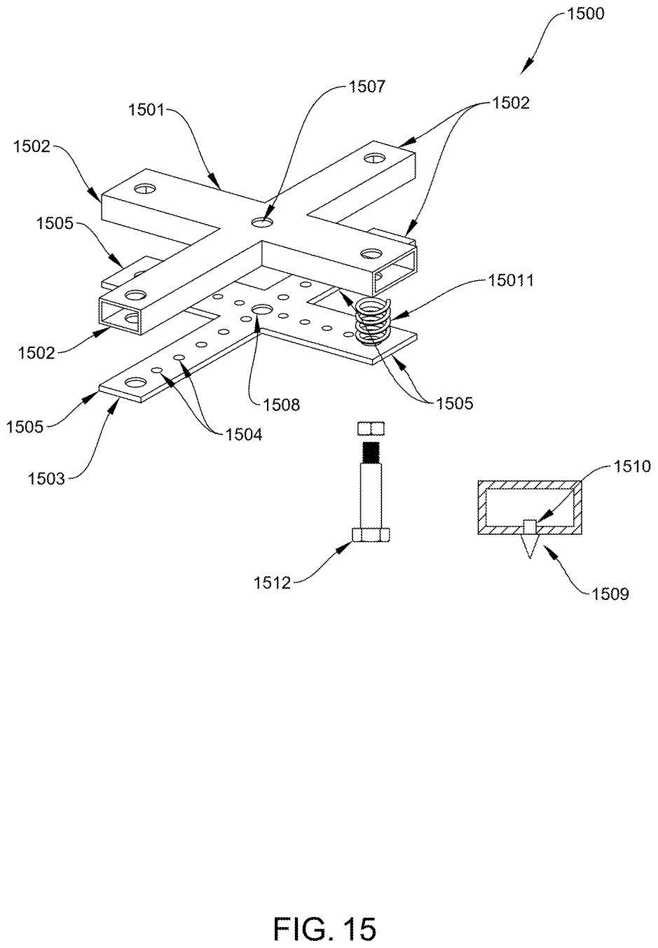

FIG. 15 shows a perspective of details of an embodiment of a compression foot 1500 that can be used with the compactor. The compression foot comprises an upper portion 1501 having rectangular legs 1502 perpendicular to each other. Each of the rectangular legs are hollow and have a top side and a bottom side. A stand-off plate 1503 with multiple openings 1504 is positioned below the rectangular legs of the upper portion. The stand-off plate also has four solid legs 1505 that line up with the rectangular legs of the upper portion. A bolt through the center hole 1507 of the upper portion and a center hole 1508 of the stand-off plate connects the stand-off plate to the upper portion of the compression foot. In an embodiment, the center holes are ¾-in in diameter. Spikes 1509 are pressed into openings 1510 in the bottom surfaces of the hollow rectangular legs and the tips of the spikes protrude below the bottom side of the hollow rectangular legs. In embodiments, the openings in the bottom surface are ¼-in in diameter. Coil springs 1511 positioned between the stand-off plate and the upper portion of the compression foot provide spacing. Shoulder bolts 1512 inserted through openings positioned near the end of the legs in the stand-off plates and the hollow rectangular legs pass through the coil springs. In embodiments the shoulder bolts have a diameter of ¼-in and a length of 2 inches. The tips of the spikes do not protrude below the stand-off plate when the compactor is not compacting trash. Openings in the stand-off plate are positioned below each of the spikes and are sized to allow the spikes to go through them. In embodiments, the compression foot comprises 16 spikes total, with four evenly-spaced spikes on each leg. In embodiments, the openings in the stand-off plate are ½-in in diameter. In embodiments, the compression foot comprises four coil springs, one on each leg of the upper portion. In embodiments, the coil springs have an inner diameter of 0.5 inches and a length of 2 inches. When the compactor is used to compact trash and the compression foot is pushed downward into the trash container, the stand-off plate contacts the bags and other containers in the trash container. As the trash compaction continues, the force against the stand-off plate compresses the coil springs, allowing the spikes in the upper portion to extend through the openings of the stand-off plate and puncture materials to help compact the trash further. As the compression foot is raised upward, the coil springs extend, and the spikes retract above the openings of the stand-off plate.

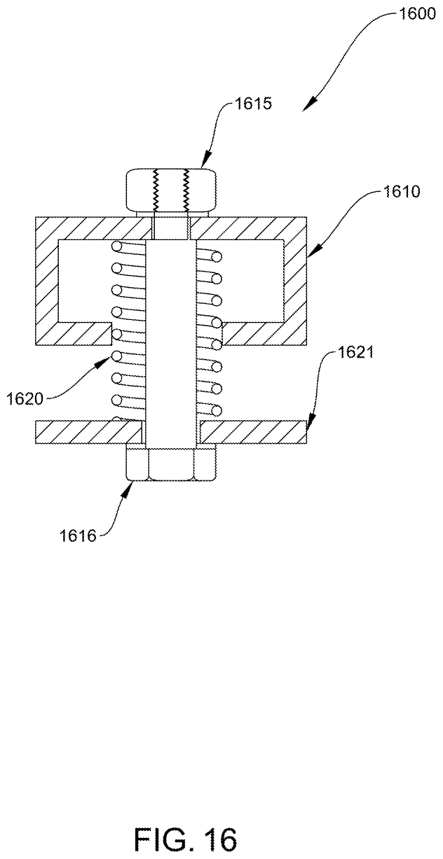

FIG. 16 shows an end-view perspective of details of an embodiment of the compression head with shield attachment. In the figure, the attachment 1600 comprises the compression head platform 1610 and the shield attachment 1621 located below the compression platform. A bolt 1616 threaded on one end connects the compression platform and the shield attachment. The bolt is inserted through coil spring 1620; the coil spring provides spacing between the shield attachment and the compression head platform. A lock nut 1615 is used to secure bolt 1621 to the compression head platform 1610. The coil spring provides spacing between the shield attachment and the compression head platform, but also compresses during compaction operation to allow the shield attachment to move closer to the compression head platform and expose the spikes. In embodiments, the threaded bolt can be a ¼-20 shoulder bolt with a length of 2-½ inches. The lock nut can be a ¼-20 nut. The coil spring can comprise material having a 1/16″ diameter and can have a 7/16″ inner diameter, a ⅝″ outer diameter, and a 2-inch length.

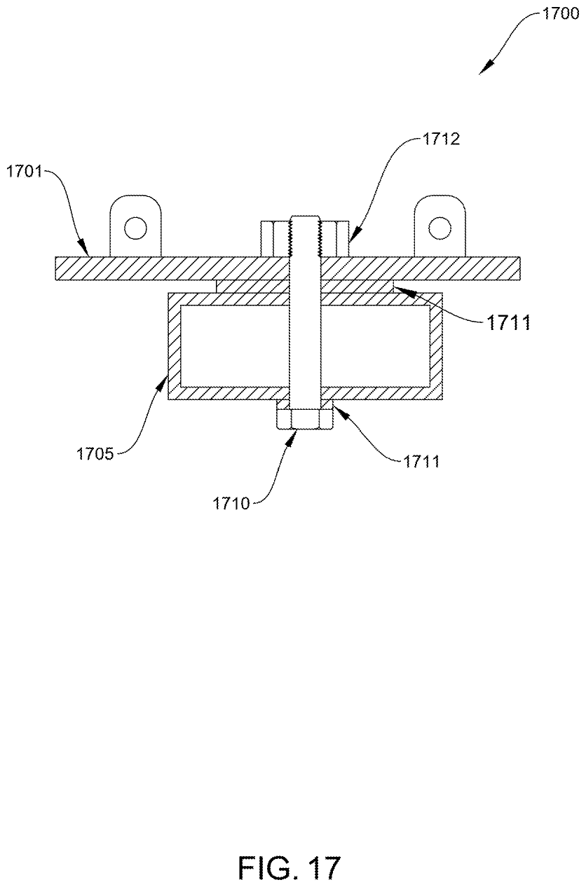

FIG. 17 shows an embodiment of a compression assembly 1700 which comprises a compression plate 1701 that is connected to a compression foot 1705. A threaded bolt 1710 is inserted through openings in the compression foot and the compression plate to connect the compression foot and compression plate. Flat washers 1711 can be used on the upper and lower surfaces of the compression foot to provide spacing and help secure the connection between the compression foot and compression plate. A lock nut 1712 is used to secure the bolt to the compression plate.

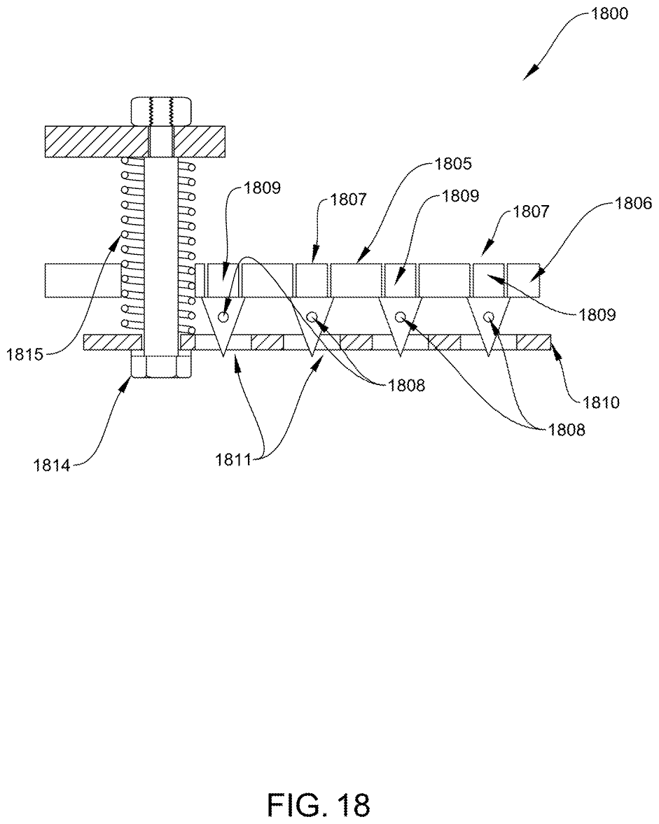

Additional details for an embodiment of the compactor that uses spikes and a shield attachment are shown in FIG. 18. The assembly 1800 comprises a compression foot 1805 that comprises a tube 1806 with openings 1807. Spikes 1808 made of steel or other material, are secured to the tube by having spike extensions 1809 press fit into the openings. A spike shield attachment 1810 is positioned below the tube with openings 1811 in the spike shield attachment positioned below the tips of the spikes 1808. A shoulder bolt 1814 inserted through the inner diameter of coil spring 1815 secures the shield attachment to the compression foot and the compactor assembly. The coil spring provides spacing between the tube and the spike shield assembly such that the tips of the spikes do not extend past the shield attachment when the compression foot is not engaged in compacting the trash. When the compression foot is engaged in compacting the trash, the coil spring is compressed, and the tips of the spikes extend below the spike shield attachment through openings 1811 in the shield attachment.

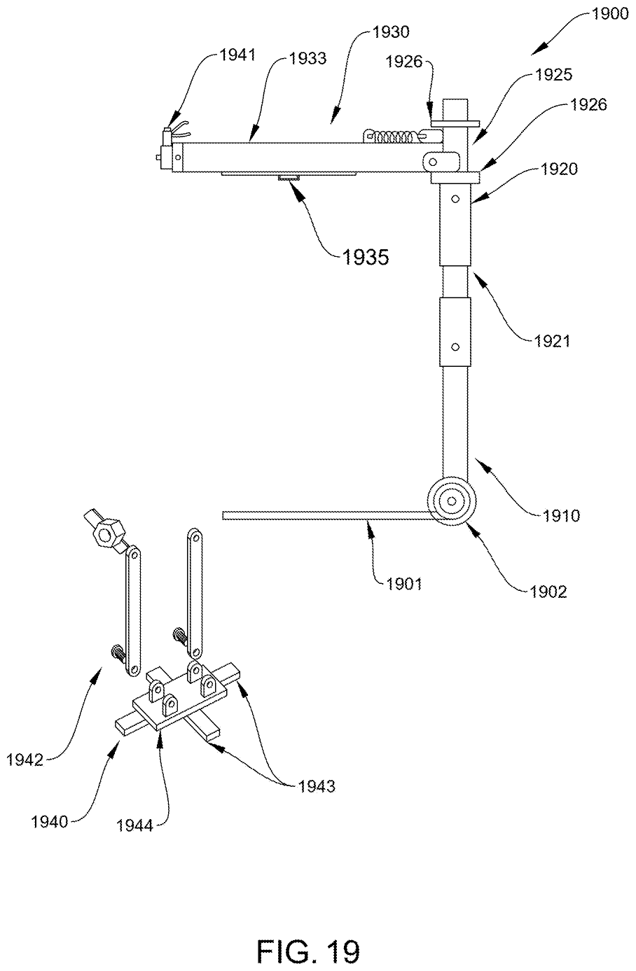

In an embodiment, the compactor can be a vertical model that can be stored in one location and used to compact trash in a trash container at another location. FIG. 19 shows a side view perspective of an embodiment of such a compactor. The compactor 1900 comprises a pedestal 1901 for resting the trash container on, and wheels 1902 for moving the compactor assembly. The base post 1910 is secured to the pedestal. The top post 1920 has an inner diameter greater than the outer diameter of the base post, and at least a portion of the base post extends into the interior of the top post. A notch 1921 in the top post provides space for the crush plate assembly 1940 to rest against the top post when the compactor is in the closed position, allowing the compactor to have a smaller space when folded. A sleeve 1925, made of steel or other material, with collars 1926 is positioned at the upper end of the top post and is connected to the compression arm 1933. The sleeve allows the compression arm to be rotated around the top post and then be dropped down for storage position. The compression arm can be attached to a C-shaped channel bracket 1930 which is also attached to the compression plate assembly 1935. Compression arms 1942 attached to the crush plate assembly are controlled by motor 1941 which can raise or lower the crush plate assembly during operation. The crush plate assembly can comprise two or more plates 1943 oriented in a transverse direction relative to each other and attached to an upper plate 1944 which is also connected to the compression arms.

In an embodiment, a stand is not used and the compactor is a portable compactor that can be placed directly on the container. The compactor can consist of a 12-24 volt linear actuator mounted on a metal frame with adjustable C channels that extend under the lip of residential street pick-up waste containers. The frame (sometimes also referred to as base support(s)) can be extended or contracted to fit the various thicknesses and width of the lip and can be extended to address the varying width of the container. The compactor can be designed as a portable completely self-contained, solar powered light weight compactor that addresses the problem of garbage overflow common in street pick-up, and can compress the garbage sufficiently to allow the lid to be closed even when full.

The portable top mounted compactors can be made from are made from 6061 t6 aircraft aluminum to be lightweight, though other materials can be used if weight is less of a factor. The portable units can utilize linear actuators and compact 12-24 inches of depth, and weigh from 8-12 lbs. depending on the type battery used. Because they apply pressure to the lip of the garbage cart/can, the portable compactors can be designed to provide no more than 300 lbs. of compacting force in order to prevent damage to the trash container.

In an embodiment, the compactor can comprise a 12-24 volt linear actuator mounted on a metal frame with adjustable C-channels that extend under the lip of the opening of pick-up waste containers in residential and business locations. The frame can be extended or contracted to fit the various thicknesses and width of the lip and can be extended to address the varying width of the container. The compactor can be designed as a portable, completely self-contained, solar powered light weight compactor that addresses the problem of garbage overflow common in street pick-up, and compresses the garbage sufficiently to allow the lid to be closed even when full. Use of the apparatus can reduce the amount of both insects and pests that are attracted to the smell of trash and can eliminate the need to stack waste on top of or beside the waste container. Stacked waste outside a container often results in garbage being scattered by both pests and wind. The apparatus of this disclosure can eliminate the need for an in-house compactor and can be used when the container will not close due to over filling.

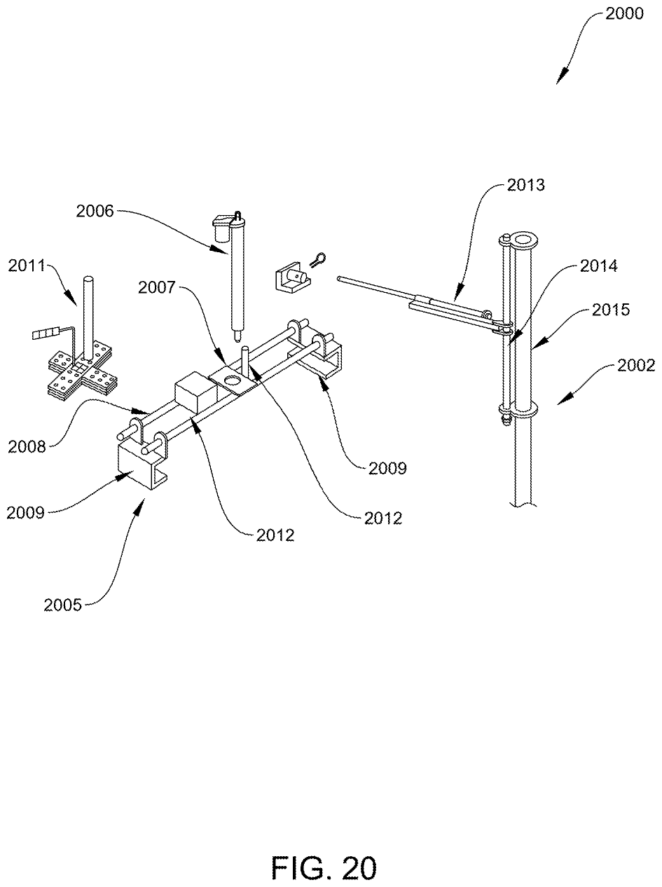

FIG. 20 shows features of an embodiment of a portable compactor that can be secured to a trash container. The compactor can be stored on a stand assembly 2002 which can be used to store the compactor when not in use and a mounting assembly 2005 that is used to secure the compactor to the trash container when it is in use. The mounting assembly comprises a mounting plate 2007, support rods 2008, and mounting brackets 2009. The mounting brackets are configured to lock under the lip of the opening of the trash container when the compactor is used to compact trash. In the embodiment, a linear actuator 2006 is positioned above the mounting assembly and a rod 2010 extends below the linear actuator, through an opening in the mounting plate. The rod is welded to a compression foot 2011 positioned below the mounting assembly. A motor on the mounting assembly provides power to the linear actuator which controls the movement of the compression foot. An optional rod 2012 attached to the mounting assembly can be used to help a user move the portable compactor into place and also provide additional support to the crush foot as the trash is compacted. The stand assembly can comprise an extension rod 2013 that can slide up or down a pipe 2014 attached to a top post 2015. The extension rod can include a pin inserted in an opening at the end of the rod. To move the portable compactor into place, the pin can be removed and the compactor can be slid off the extension rod and placed onto the trash container. Alternatively, the compactor can remain attached to the extension arm and the extension arm can be rotated to position the compactor into place on the trash container.

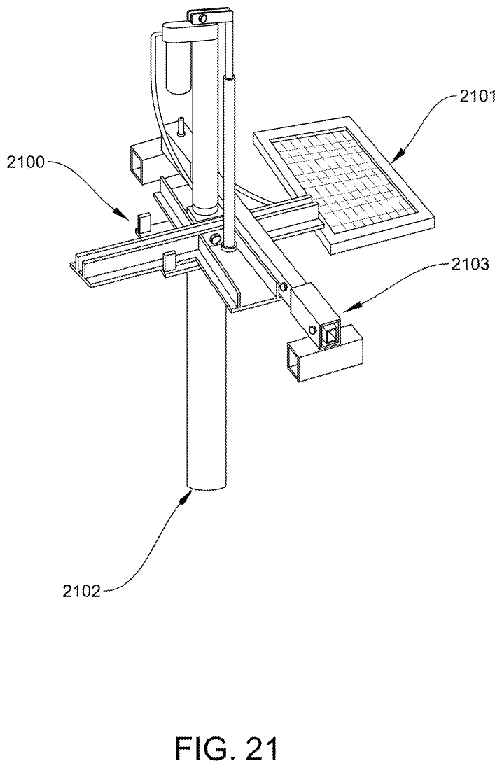

FIG. 21 shows features of an embodiment of a compactor 2100 that is powered by solar energy using a photoelectric device or solar module 2101. In this embodiment, the portable compactor rests on a stand assembly 2102 that is secured to the ground. The compactor can be attached to the stand assembly in multiple ways including straps, pin connectors, docking components. The compactor can be removed from the stand assembly and placed on a trash container using extension arms 2103 that span the opening of the trash container and secure the compactor to the trash container.

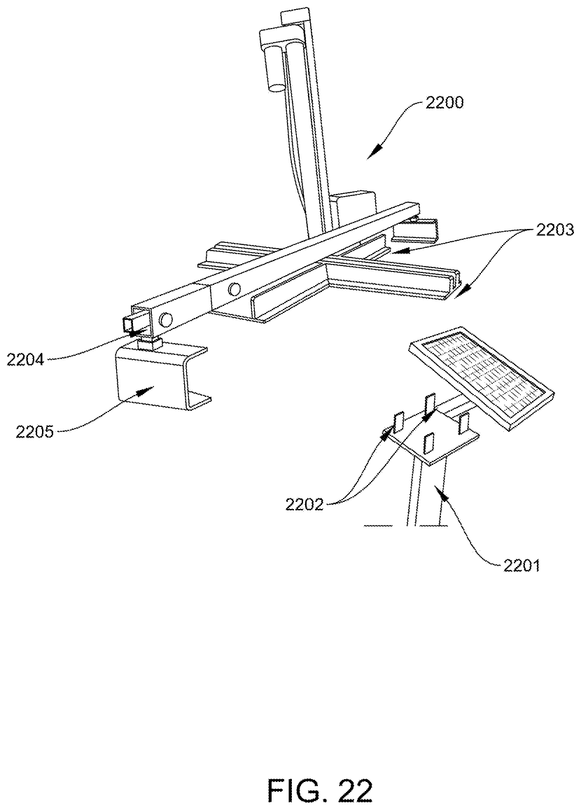

FIG. 22 shows an embodiment of the compactor 2200 that uses solar power. The solar module 2201 can be electrically connected to the compactor's motor directly to provide power in use, or the solar module can be used to charge a battery that can power the motor of the compactor. The solar module can be disconnected from the battery so that the compactor can be removed from the stand assembly and placed on the trash container.

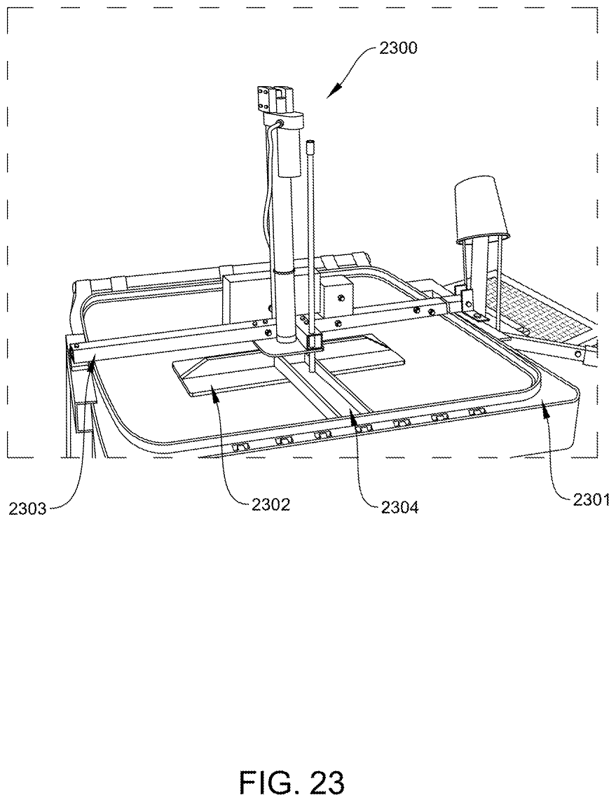

FIG. 23 shows an embodiment of the compactor 2300 wherein the solar module 2301 is electrically connected to the compactor using male and female pin connectors 2302. Such connectors can be disconnected and re-connected with minimal effort from the user. The number of connectors used can vary for a variety of reason including power requirements for the motor, the size and number of solar modules used, the gauge of the wires used, and other configuration requirements for the compactor.

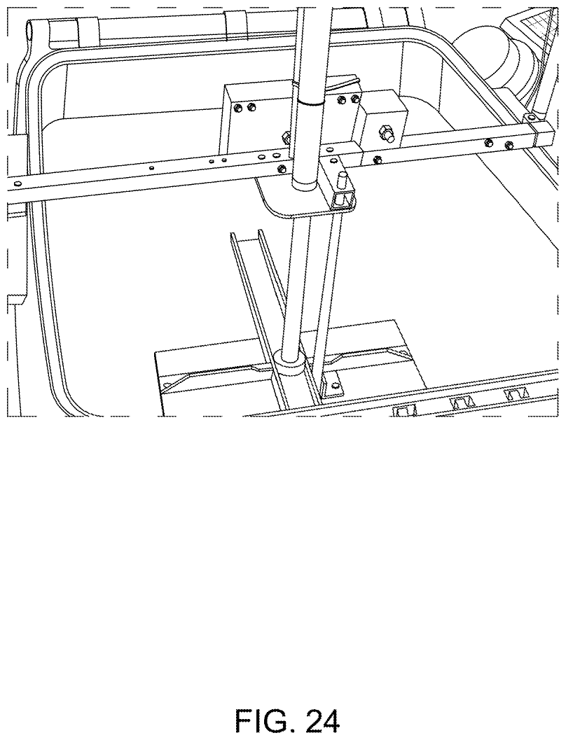

FIG. 24 shows an embodiment of the portable compactor 2400 that has been removed from the stand assembly 2401. In this embodiment, posts 2402 on the stand assembly are used to hold the compactor in place when it is not being used. In this embodiment, the compression foot comprises two rectangular plates 2403 that are perpendicular to each other and the compression foot is positioned just below the extension arms 2404 when the compactor is not in use. Clamps 2405 on the extension arms help secure the compactor to the trash container when in use.

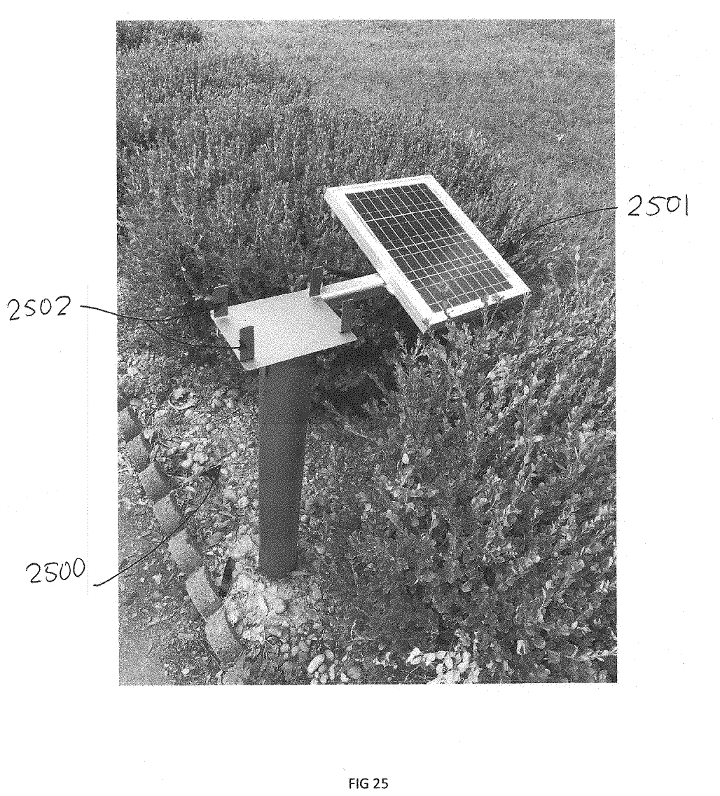

FIG. 25 shows an embodiment of the stand assembly 2500 and solar module 2501 without the portable compactor in place. The solar module is disconnected from the compactor in the figure. The stand assembly is secured to the ground and posts 2502 on the stand assembly can be used to hold the portable compactor in place when not in use.

In embodiments, the portable apparatus can fit over the top of the container opening and can comprise “C” channel ends which slide over the container lip and lock it into place. The ram foot can be attached to the linear actuator and move vertically up or down. Power to the apparatus can be controlled with a switch. The down movement of the ram foot compacts the container content when the switch is moved to the up position. After use, one or more of the C-channels can be slid in toward the center when the compacting is completed. The apparatus can then be moved and placed on a charging stand and plugged into a charger, battery or photovoltaic cell which is grounded to the stand.

In some embodiments a portable compactor apparatus for compacting material in a container comprises:
1) at least one support that extends across the top of the opening of the container/garbage can, and
2) a linear actuator attached to the at least one support, the linear actuator having an extendable and retractable shaft, the shaft having a proximal end within the actuator and a distal end,
3) a compression foot connected to the distal end of the shaft, and
4) Control means for controlling extension and retraction of the shaft,
the container having a top lip portion, the base support positioned on the top lip portion, the linear actuator having a first position and a second position, in the first position the shaft is fully retracted (in some embodiments this can mean “fully retracted into the linear actuator”), in the second position the shaft is extended further below the top lip portion of the container.

The foot can have two rectangular pieces that overlap one another at an angle close to 90 degrees. However, other angles could also be used. The control means can be a motor on the actuator as shown with the black electrical cord extending from it. Power can be from a battery or from a solar or other electrical source. A toggle switch can be used to extend and/or retract the shaft. The container/garbage can have an upper lip. At each end of the base support there are C-channels that can fit about the lip of the container. The C-channels as shown are close to perpendicular to the base support. The base support can be constructed of elongated material that can be extended such that the C-channels can fit about the upper lip of containers of various sizes.

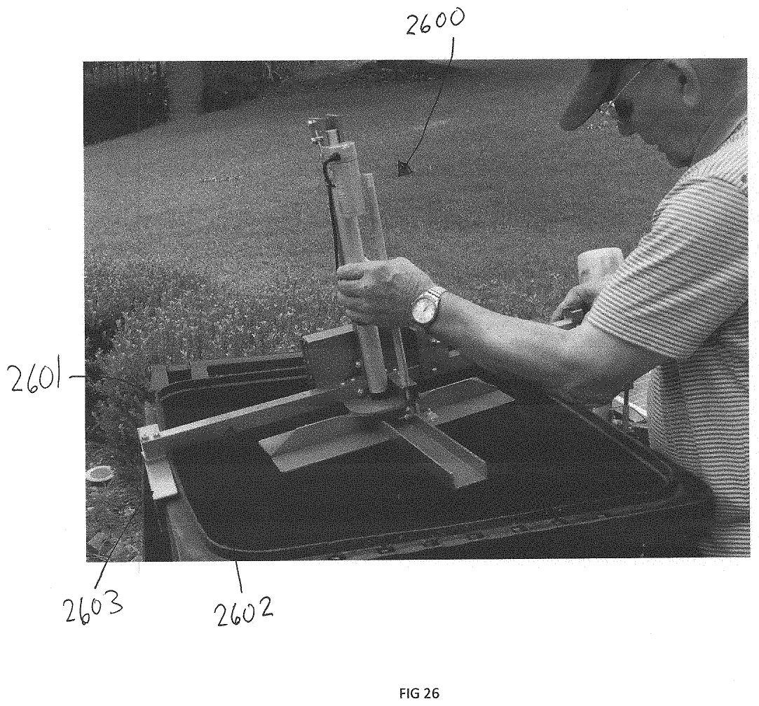

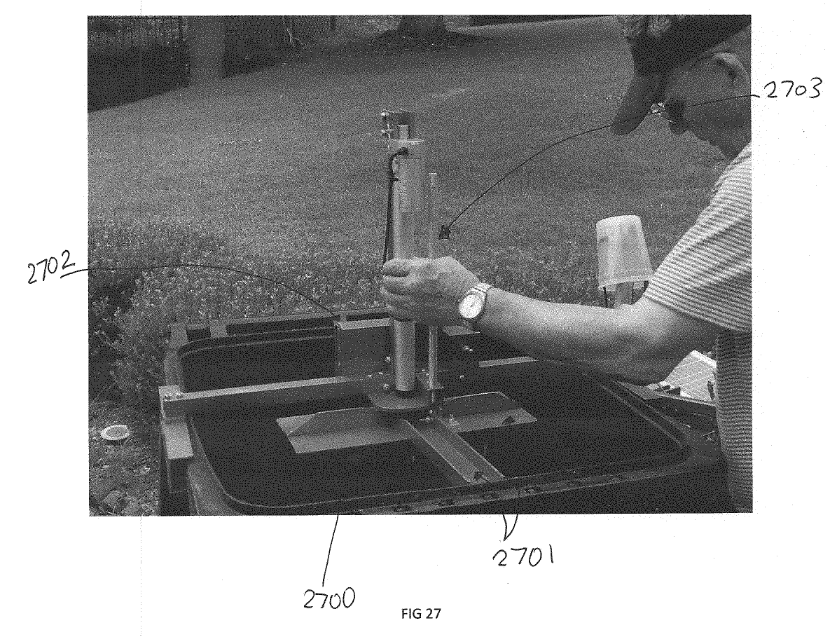

The portable compactor 2600 can be positioned onto a trash container 2601 as shown in FIG. 26 and FIG. 27. The extension arms 2602 span the opening of the trash container and provides support for the compactor. Clamps 2603 on the extension arms help secure the compactor to the trash container. The crush foot 2700 is positioned below the extension arms. The rectangular plates 2701 fit fully inside the opening of the trash container. At least a portion of the motor 2702 and actuator assembly 2703 are positioned above the extension arms.

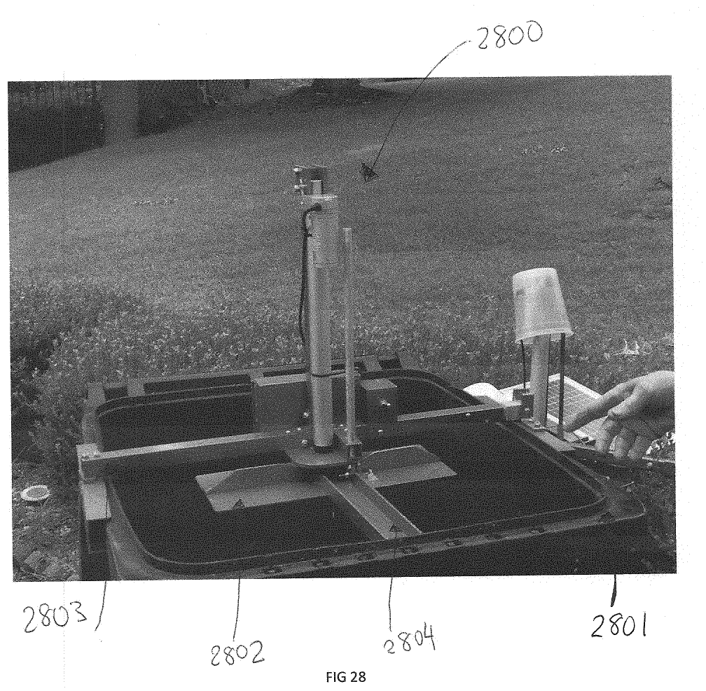

FIG. 28 shows an embodiment of the portable compactor 2800 in position on the trash container 2801. In this embodiment the rectangular plate 2802 that is parallel to the extension arms 2803 is wider than the rectangular plate 2804 that is perpendicular to the extension arms. In other embodiments, the widths of both rectangular plates are substantially equal. In other embodiments, the width of the plate that is perpendicular to the extension is greater than the width of the plate that is parallel to the extension arms.

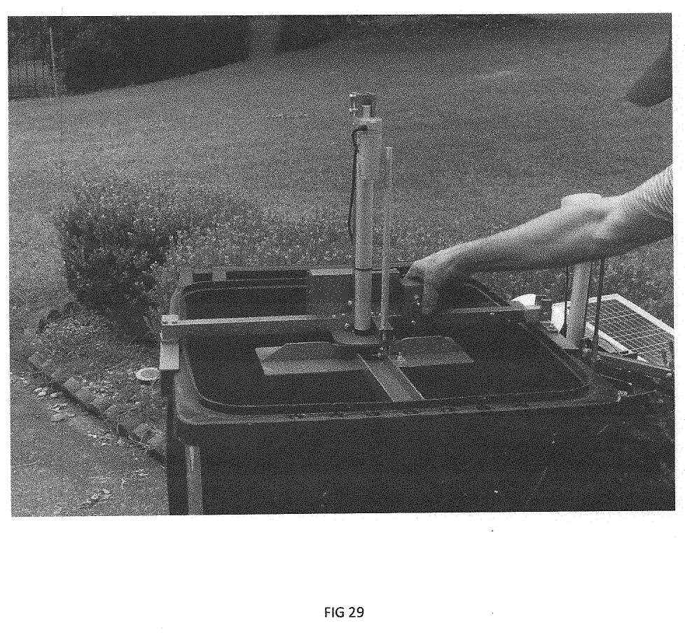

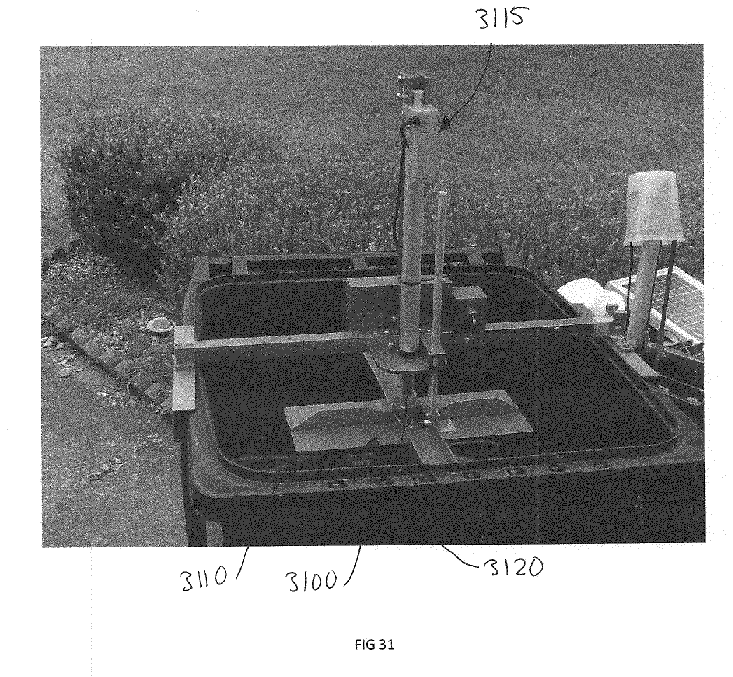

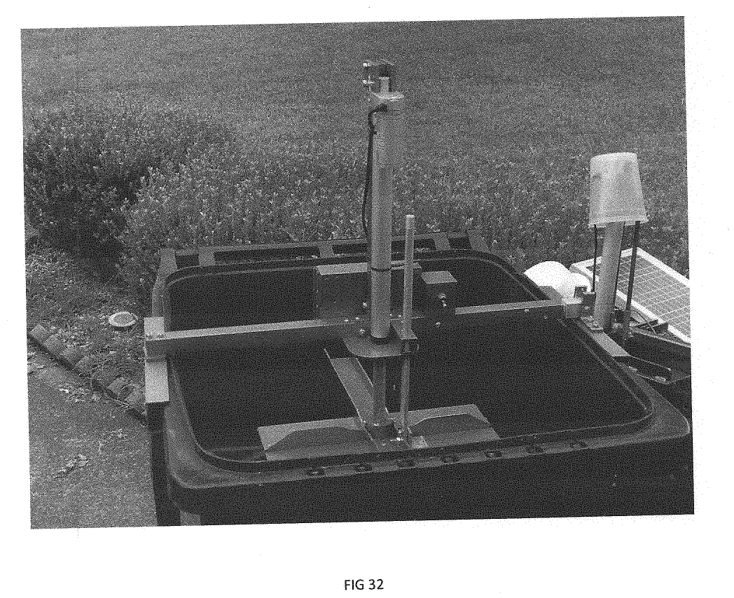

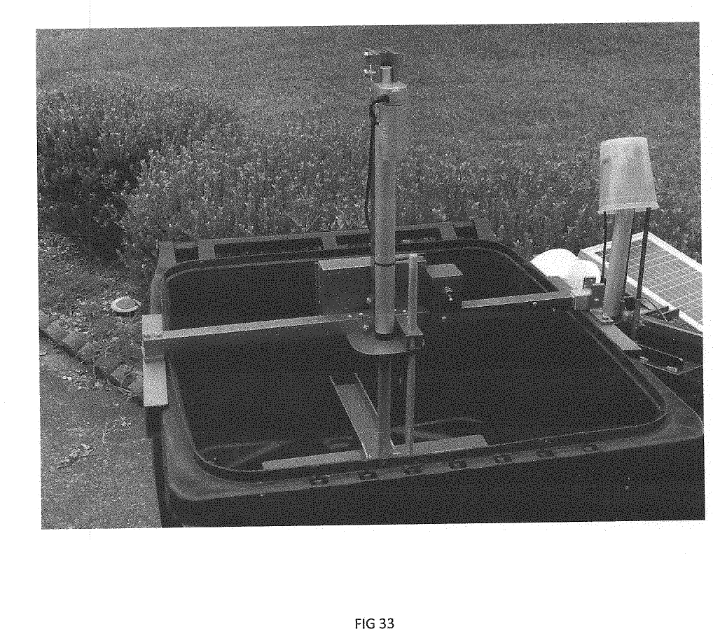

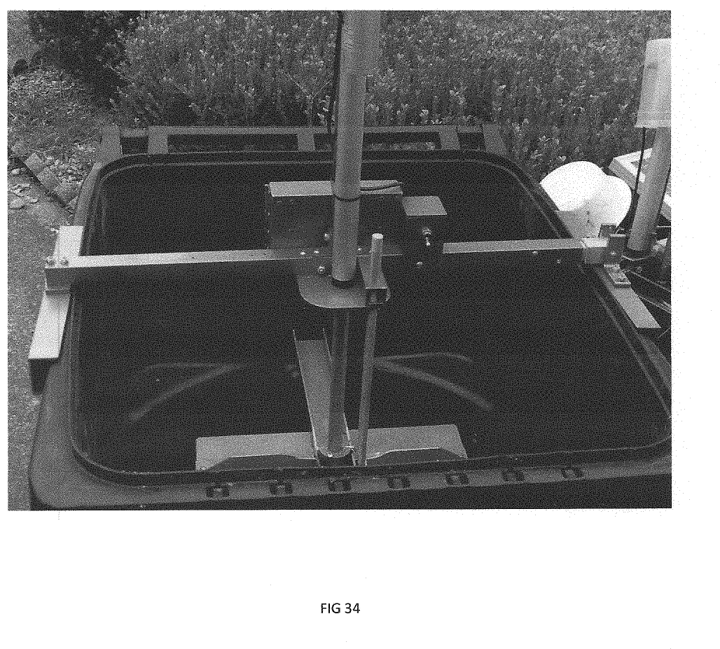

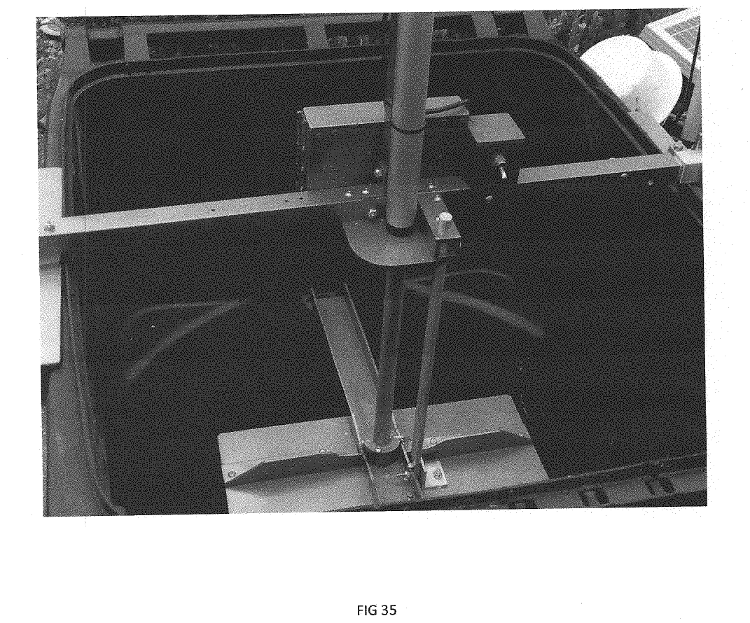

FIG. 29-FIG. 35 show an embodiment of the compactor as it is used to compact trash inside a trash container. The crush foot 3100 is moved downward to compact the trash 3110. The linear actuator 3115 controls the lowering of a shaft 3120 connected to the crush foot; the rod extends further and further below the linear actuator as crush foot moves downward and the trash is fully compacted. As shown in FIG. 31, the shaft can be seen beneath the linear actuator as it begins to extend out of the tube below the actuator. More of the shaft can be seen in FIG. 32 as the shaft extends further. In FIGS. 33-34 the shaft extends further out still. In FIG. 35 the shaft is further extended still. A second support rod 3130 connected to the crush foot also moves downward as the trash is compacted. In embodiments, a majority of the second support rod is positioned below the linear actuator when the trash is compacted. In embodiments, the second support rod can be used to stabilize the crush foot and help maintain pressure of the crush foot against the trash by preventing the crush foot from rotating or pivoting during use. The crush foot can be lowered up to 36 inches, up to 30 inches, up to 24 inches, up to 18 inches, up to 12 inches, or other length needed to compact the trash in the container. In FIG. 35 the compression head is extended deeply into the container.

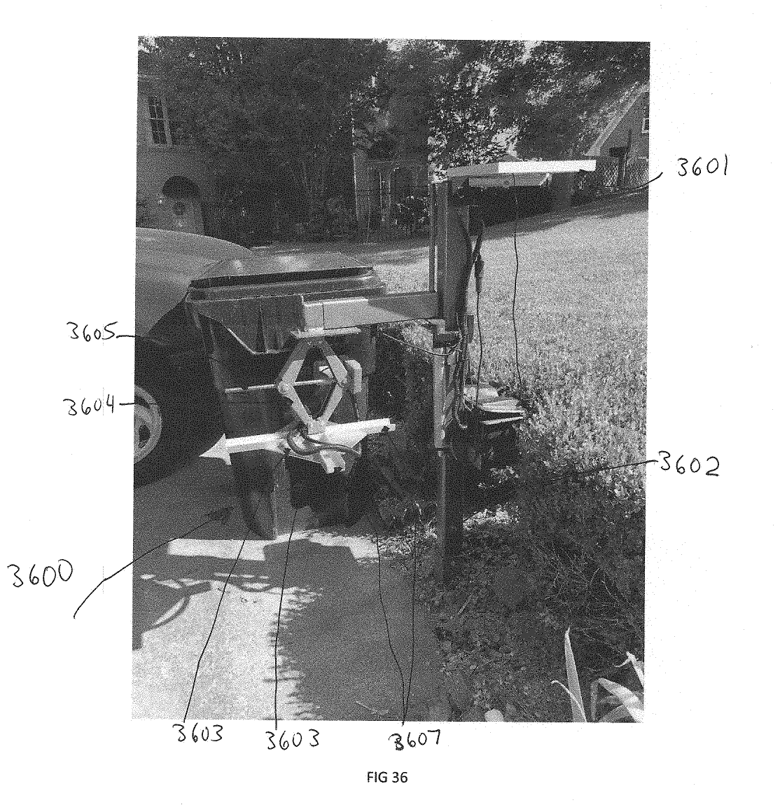

FIG. 36 shows an embodiment of the compactor 3600 wherein a solar module 3601 is used to provide power to the compactor and where the base post 3602 of the compactor is secured to the ground. In this embodiment, the trash container can be wheeled over to the compactor and positioned under the crush foot 3603 to have the trash compacted. In this embodiment, a scissor jack 3604 is used to raise and lower the crush foot. When the threaded rod 3605 is turned, the scissor jack moves the crush foot either up or down, depending on whether the rod is turned clockwise or counterclockwise. In other embodiments, a rod and linear actuator could be used as well. In this embodiment, the crush foot comprises a diamond-shaped plate 3606 that is connected to 2 perpendicular support beams 3607.

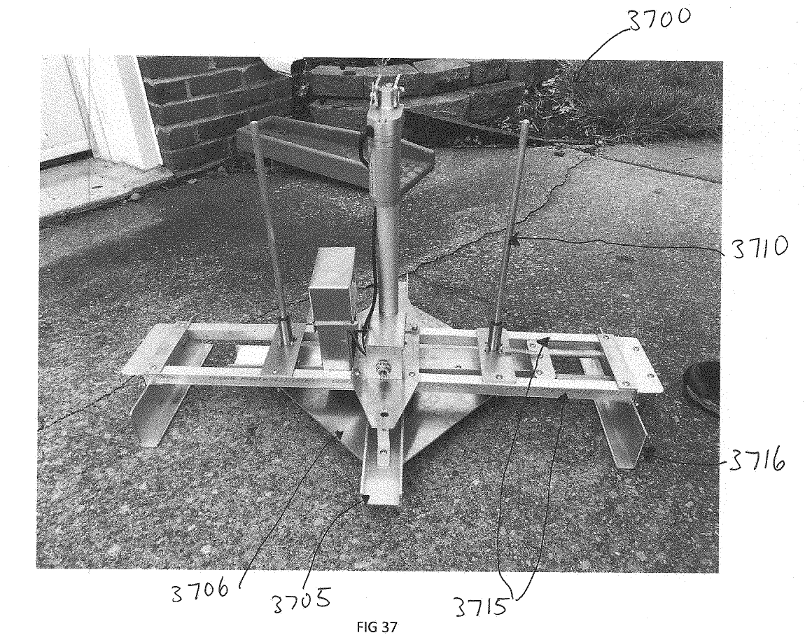

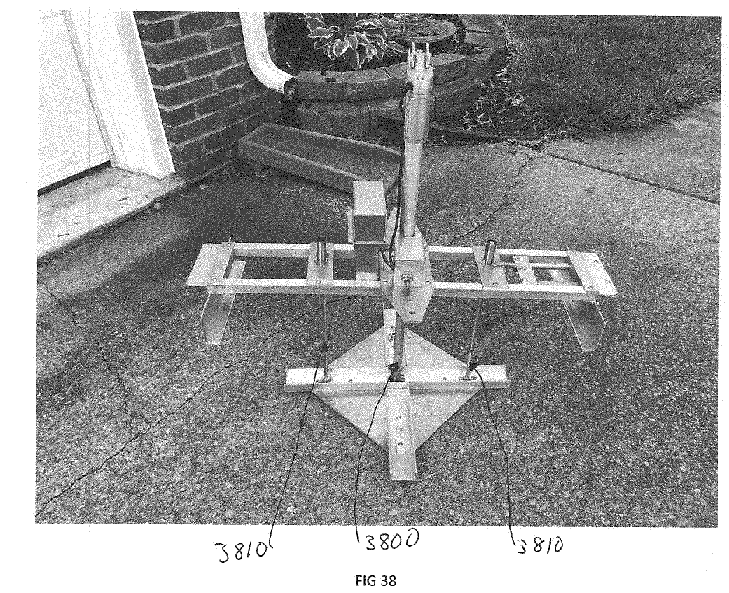

FIG. 37 and FIG. 38 show an embodiment of the portable compactor 3700 wherein a linear actuator is used to control the movement of the crush foot 3705 and two additional support rods 3710 are connected to the diamond-shaped plate 3706 of crush foot to provide extra support. The two support arms are positioned between two extension arms 3715 that span the opening of the trash container. L-shaped extensions 3716 below the extension arms are used to help secure the portable compactor to the trash container. When the compactor is used to compact trash, the linear actuator is used to lower the crush plate by moving a rod 3800 connected to the crush plate and extending below the linear actuator. The two support rods 3810 also move with the crush plate as it is lowered into the trash container.

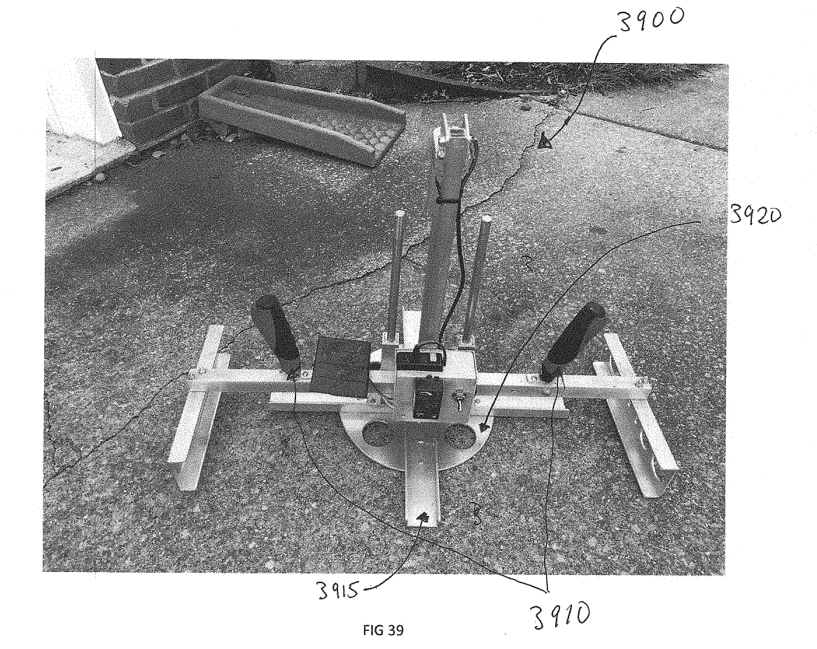

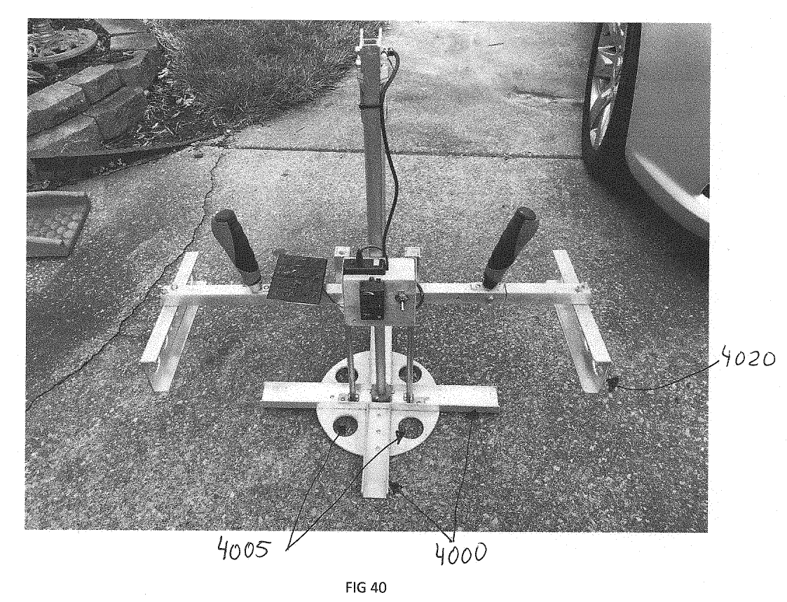

FIGS. 39 and 40 show an embodiment of the portable trash compactor 3900 where handles 3910 attached to the extension arms can be used to aid in moving and positioning the compactor. In this embodiment the crush foot 3915 comprises a circular plate 3920 that is attached to two perpendicular support bars 4000. The circular plate can comprise openings 4005 that can aid in compacting trash. Two support rods 4010 attached to the crush foot provide support to the plate as the trash is compacted. In embodiments, the support rods are positioned between the handles. In other embodiments, the handles can be positioned between the support rods. C-shaped extensions 4020 below the extension arms are used to secure the compactor to the trash container. A linear actuator is used to raise and lower the crush foot when the compactor is operated.

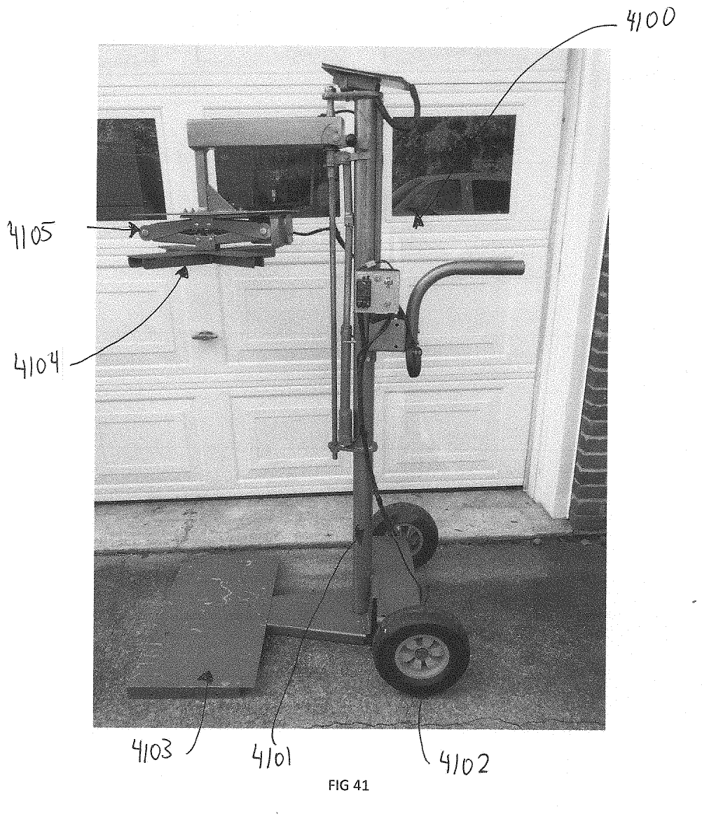

FIG. 41 shows an embodiment of the compactor 4100 wherein the base post 4101 is attached to a stand comprising wheels 4102 and a platform 4103 for supporting the trash container. In this embodiment, the movement of the crush foot 4104 is controlled by using a scissor jack 4105 attached to a threaded rod positioned above the crush foot. The assembly can also move up and down on the base post.

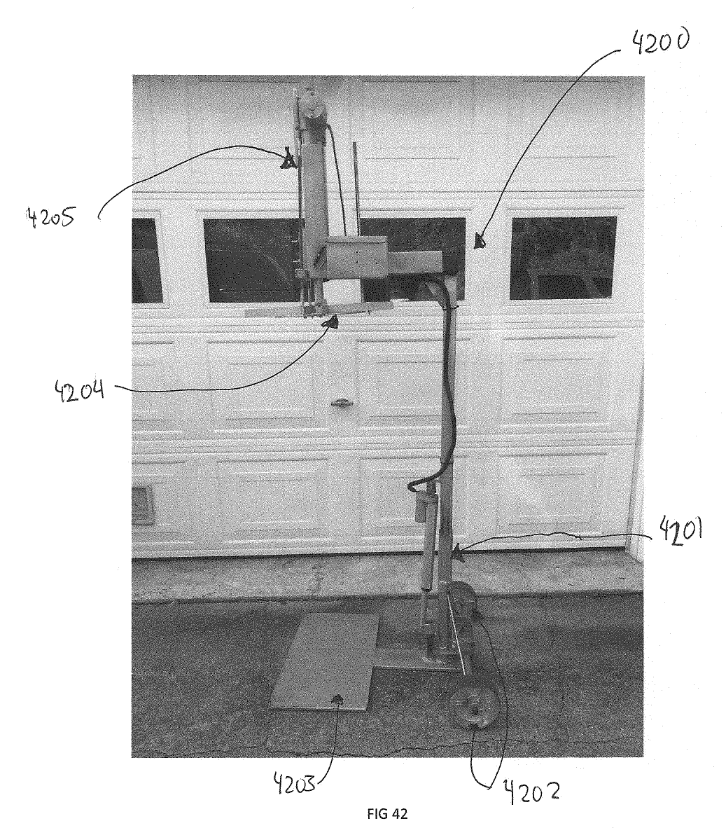

FIG. 42 shows an embodiment of the compactor 4200 wherein the base post 4201 is attached to a stand comprising wheels 4202 and a platform 4203 for supporting the trash container. In this embodiment, the movement of the crush foot 4204 is controlled by a linear actuator 4205 positioned above the crush foot. The assembly can also move up and down the base post.

In some embodiments the compression head can utilize spikes as described elsewhere in the application and can include the safety feature for those spikes as taught herein.

It should be noted that in some embodiments, features in FIGS. 1-25 have been considered and can be added to the embodiments in FIGS. 26-42. It is also true that the features in FIGS. 26-42 have been considered and can be added to the embodiments in FIGS. 1-25.

Embodiments of the apparatus of this disclosure can comprise a portable compactor apparatus for compacting material in a container, wherein the portable compactor apparatus comprises
a. At least one base support,
b. A linear actuator attached to the at least one base support, the linear actuator having an extendable and retractable shaft, the shaft having a proximal end within the actuator and a distal end,
c. A compression head connected to the distal end of the shaft, and
d. Control means for controlling extension and retraction of the shaft,
The container having a top lip portion, the base support positioned on the top lip portion, the linear activator having a first position and a second position, in the first position the shaft is fully retracted into the linear actuator, in the second position the shaft is extended further below the top lip portion of the container.

Other embodiments of the apparatus of this disclosure can include a portable compactor apparatus for compacting material in a container, wherein the portable compactor apparatus comprises

a) A stationary base post connected to one or more base supports,

b) A movable top post wherein the top post is movable relative to the base post and the inner diameter of the top post is greater than the outer diameter of the base post,

c) A compression head connected to the top post and the base post by connectors wherein the compression head and connectors are configured to enable the compression head to extend in a direction perpendicular to the top post and base post during compacting operation and to allow the compression head to be folded in a direction parallel to the top post and base post when the apparatus is not in use,

d) A compacting platform attached to the compression head and configured below the compression head wherein the compacting platform comprises a plurality of spikes extending below the bottom of the compacting platform, and

e) Control means for controlling the vertical movement of the top post and compression head.

Other embodiments of the apparatus can include the following features:

1) The base supports can comprise a plurality of beams that span the opening of the container.

2) The compacting platform can extend below the base supports during compaction operations.

3) The apparatus can comprise a threaded rod that connects the top post to the base post wherein the threaded rod is in the interior of the top post and extends in the axial direction of the top post along at least a portion of the length of the top post.

4) The control means can comprise an electric motor connected to a threaded rod.

5) The electric motor or linear actuator can be powered by electricity from a battery or photovoltaic cell.

6) The control means can comprise a hand crank with a handle wherein the handle is connected to the threaded rod.

7) The control means can comprise a linear actuator.

8) The support beams can be adjustable to fit container openings of different sizes.

9) The compressor platform can comprise first and second crossing members wherein the first member extends in a perpendicular direction from the second member.

10) The apparatus can comprise a safety pressure plate positioned below the compaction platform and below the base of the spikes wherein the plate comprises openings sized to permit the tips of the spikes to penetrate below the plate during compacting operations.

11) The safety pressure plate can be positioned below the tips of the spikes when no compacting operations are being performed.

12) The portable apparatus can comprise a spring between the compaction platform and the safety pressure plate.

13) The portable apparatus can comprise a plurality of springs wherein each of the springs in the plurality of springs have the same length and spring constant.

14) The portable apparatus can comprise a plurality of springs wherein at least one spring in the plurality of springs has a different length or spring constant than the other springs.

17) The portable apparatus of embodiment 2 or 10 wherein the support beams comprise a spring located within a channel of the support beam.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

I claim:

1. A portable compactor apparatus for compacting material in a container, wherein the portable compactor apparatus comprises
a. At least one base support,
b. A linear actuator attached to the at least one base support, the linear actuator having an extendable and retractable shaft, the shaft having a proximal end within the actuator and a distal end,
c. A compression head connected to the distal end of the shaft, and
d. Control means for controlling extension and retraction of the shaft,
the container having a top lip portion, the base support positioned on the top lip portion, the linear activator having a first position and a second position, in the first position the shaft is fully retracted (in some embodiments this can mean “fully retracted into the linear actuator”), in the second position the shaft is extended further below the top lip portion of the container.

2. A portable compactor apparatus for compacting material in a container, wherein the portable compactor apparatus comprises
a) A stationary base post connected to one or more base supports,
b) A movable top post wherein the top post is movable relative to the base post and the inner diameter of the top post is greater than the outer diameter of the base post,
c) A compression head connected to the top post and the base post by connectors wherein the compression head and connectors are configured to enable the compression head to extend in a direction downward from the top post and base post during compacting operation and to allow the compression head to be folded in a direction parallel to the top post and base post when the apparatus is not in use,
d) A compacting platform attached to the compression head and configured below the compression head wherein the compacting platform comprises a plurality of spikes extending below the bottom of the compacting platform, and
e) Control means for controlling the vertical movement of the top post and compression head.

3. The portable apparatus of claim 2 further comprising a threaded rod that connects the top post to the base post wherein the threaded rod is in the interior of the top post and extends in the axial direction of the top post along at least a portion of the length of the top post.

4. The portable apparatus of claim 3 wherein the control means comprises an electric motor connected to the threaded rod.

5. The portable apparatus of claim 4 wherein the electric motor is powered by electricity from a battery or photovoltaic cell.

6. The portable apparatus of claim 5 wherein the control means comprises a hand crank with a handle wherein the handle is connected to the threaded rod.

7. The portable apparatus of claim 2 wherein the control means comprises a linear actuator.

8. The portable apparatus of claim 7 wherein the linear actuator is powered by electricity from a battery or photovoltaic cell.

10. The portable apparatus of claim 1 wherein the support beams are adjustable to fit container openings of different sizes.

11. The portable apparatus of claim 1 wherein the compressor platform (or compression head) comprises first and second crossing members wherein the first member extends in a perpendicular direction from the second member.

12. The portable apparatus of claim 2 further comprising a safety pressure plate positioned below the compaction platform (or compression head) and below the base of the spikes wherein the plate comprises openings sized to permit the tips of the spikes to penetrate below the plate during compacting operations.

13. The portable apparatus of claim 12 wherein the safety pressure plate is positioned below the tips of the spikes when no compacting operations are being performed.

14. The portable apparatus of claims 12 further comprising a spring between the compaction platform and the safety pressure plate.

15. The portable apparatus of claim 14 comprising a plurality of springs wherein each of the springs in the plurality of springs have the same length and spring constant.

16. The portable apparatus of claim 14 comprising a plurality of springs wherein at least one spring in the plurality of springs has a different length or spring constant than the other springs.

17. A portable compactor apparatus for compacting material in a container, wherein the portable compactor apparatus comprises
a. At least one wheel and a container support platform,
b. At least one base support,
c. A linear actuator attached to the at least one base support, the linear actuator having an extendable and retractable shaft, the shaft having
d. a proximal end within the actuator and a distal end,
e. A compression head connected to the distal end of the shaft, and
f. Control means for controlling extension and retraction of the shaft,
the container having a top lip portion, the base support positioned on the top lip portion, the linear activator having a first position and a second position, in the first position the shaft is fully retracted (in some embodiments this can mean “fully retracted into the linear actuator”), in the second position the shaft is extended further below the top lip portion of the container.

18. The apparatus of claim 17 further comprising a compacting platform attached to the compression head and configured below the compression head wherein the compacting platform comprises a plurality of spikes extending below the bottom of the compacting platform

19. The apparatus of claim 18 further comprising a safety pressure plate positioned below the compaction platform (or compression head) and below the base of the spikes wherein the plate comprises openings sized to permit the tips of the spikes to penetrate below the plate during compacting operations.

20. The apparatus of claim 19 wherein the safety pressure plate is positioned below the tips of the spikes when no compacting operations are being performed.
